(19) United States
(12) Patent Application Publication
(10) Pub. No.: US 2026/0291839 A1
(43) Pub. Date: Sep. 24, 2026

(54) ELECTRONIC DEVICE, METHOD, AND NON-TRANSITORY COMPUTER READABLE STORAGE MEDIUM FOR TRANSMITTING WIRELESS NETWORK INFORMATION

(71) Applicant: Samsung Electronics Co., Ltd., Suwon-si (KR)

(72) Inventors: Namjin KIM, Suwon-si (KR); Minkyung JO, Suwon-si (KR); Sungmi PARK, Suwon-si (KR); Sijae KIM, Suwon-si (KR); Jongman PARK, Suwon-si (KR)

(21) Appl. No.: 19/430,952

(22) Filed: Dec. 23, 2025

Related U.S. Application Data
(63) Continuation of application No. PCT/KR2025/020234, filed on Dec. 1, 2025.

(30) Foreign Application Priority Data
Mar. 21, 2025 (KR) 10-2025-0036829
Apr. 24, 2025 (KR) 10-2025-0053701
May 14, 2025 (KR) 10-2025-0062863

(51) Int. Cl. H04L 43/0811; H04W 76/18; H04W 76/20

(52) U.S. Cl. CPC H04L 43/0811; H04W 76/18; H04W 76/20

(57) ABSTRACT

A server device is provided. The server device includes memory and at least one processor. The instructions, when executed by the at least one processor individually or collectively, cause the server device to identify a connection status with the server device of an Internet of Things (IoT) device, based on the connection status of the IoT device being an offline status, identify a connection status of one or more other IoT devices, registered with respect to an access point (AP) device to which the IoT device connects for connecting to the server device, based on the connection status of the one or more other IoT devices being the offline status, transmit, to an electronic device, a first message representing that a network connection problem occurred in association with the AP device, and receive a second message including second network information available for accessing the AP device or another AP device.

### CROSS-REFERENCE TO RELATED APPLICATIONS

This application is a continuation application, claiming priority under 35 U.S.C. § 365(c), of an International application No. PCT/KR2025/020234, filed on December 1, 2025, which is based on and claims the benefit of a Korean patent application number 10-2025-0036829, filed on March 21, 2025, in the Korean Intellectual Property Office, of a Korean patent application number 10-2025-0053701, filed on April 24, 2025, in the Korean Intellectual Property Office, and of a Korean patent application number 10-2025-0062863, filed on May 14, 2025, in the Korean Intellectual Property Office, the disclosure of each of which is incorporated by reference herein in its entirety.

### TECHNICAL FIELD

The disclosure relates to an electronic device, a method, and a non-transitory computer readable storage medium for transmitting wireless network information.

### BACKGROUND ART

An electronic device may store wireless network information. For example, the electronic device may attempt to access a device that provides the wireless network using the wireless network information. For example, the device that provides the wireless network may include a router. An Internet of Things (IoT) device may connect to the wireless network provided by the router by connecting to the router. The IoT device may be connected to a server by connecting to the wireless network. The IoT device connected to the server may transmit information to the server.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer readable storage medium for transmitting wireless network information.

Additional aspects will be set forth in part in the description which follows and, in part, will be apparent from the description, or may be learned by practice of the presented embodiments.

In accordance with an aspect of the disclosure, a method performed by a server device is provided. The method includes identifying a connection status with the server device of an internet of things (IoT) device, based on the connection status of the IoT device being an offline status, identifying a connection status of one or more other IoT devices, registered with respect to an access point (AP) device to which the IoT device connects for connecting to the server device, based on the connection status of the one or more other IoT devices being the offline status, transmitting, to an electronic device, a first message representing that a network connection problem occurred in association with the AP device, the first message including first network information used for accessing the AP device such that the electronic device determines whether the first network information is available for accessing the AP device, and receiving a second message including second network information available for accessing the AP device or another AP device, transmitted from the electronic device such that the first network information is updated to the second network information.

In accordance with another aspect of the disclosure, a server device is provided. The server device includes memory including one or more storage media storing instructions, at least one processor including processing circuitry. The instructions, when executed by the at least one processor individually or collectively, cause the server device to identify a connection status with the server device of an internet of things (IoT) device, based on the connection status of the IoT device being an offline status, identify a connection status of one or more other IoT devices, registered with respect to an access point (AP) device to which the IoT device was accessed for connecting to the server device, based on the connection status of the one or more other IoT devices being the offline status, transmit, to an electronic device, a first message representing that a network connection problem occurred in association with the AP device, the first message including first network information used for accessing the AP device, such that the electronic device determines whether the first network information is available for accessing the AP device, and receive a second message, including second network information available for accessing the AP device or another AP device, transmitted from the electronic device, such that the first network information is updated to the second network information.

In accordance with another aspect of the disclosure, one or more non-transitory computer readable storage medium storing one or more computer programs including computer-executable instructions that, when executed by one or more processors of a server device individually or collectively, cause the server device to perform operations are provided. The operations include identifying, a connection status with the server device of an internet of things (IoT) device, based on the connection status of the IoT device being an offline status, identifying, a connection status of one or more other IoT devices, registered with respect to an access point (AP) device to which the IoT device connects for connecting to the server device, based on the connection status of the one or more other IoT devices being the offline status, transmitting, to an electronic device, a first message representing that a network connection problem occurred in association with the AP device, the first message including first network information used for accessing the AP device such that the electronic device determines whether the first network information is available for accessing the AP device, and receiving, a second message including second network information available for accessing the AP device or another AP device, transmitted from the electronic device such that the first network information is updated to the second network information.

In accordance with another aspect of the disclosure, an electronic device is provided. The electronic device includes first communication circuitry, second communication circuitry, memory including one or more storage media storing instructions, and at least one processor including processing circuitry communicatively coupled to the first communication circuitry, the second communication circuitry and the memory, wherein the instructions, when executed by the at least one processor individually or collectively, cause the electronic device to receive, from a server device, via the first communication circuitry, a first message representing that a network connection problem occurred in association with an access point (AP) device, wherein one or more internet of things (IoT) devices are registered in the server device in association with the electronic device, based on receiving the first message, attempt to access the access point (AP) device, using first network information included in the first message, the first network information used by the one or more IoT devices for accessing the AP device, based on a success of accessing the AP device in accordance with the attempt using the first network information, transmit, to the server device, via the first communication circuitry, a second message representing that the first network information is available for an access to the AP device, based on a failure of accessing the AP device in accordance with the attempt using the first network information, obtain second network information for accessing the AP device or another AP device, and based on a success of accessing the AP device or the another AP device using the second network information, transmit, to the IoT device registered in the server device, via the first communication circuitry or the second communication circuitry, the second network information.

In accordance with another aspect of the disclosure, a method performed by an electronic device including first communication circuitry and second communication circuitry is provided. The method includes receiving, from a server device, via the first communication circuitry, a first message representing that a network connection problem occurred in association with an access point (AP) device. One or more IoT devices are registered in the server device in association with the electronic device. The method includes, based on receiving the first message, attempting to access the access point (AP) device, using first network information included in the first message. The first network information is used by the one or more IoT devices for accessing the AP device. The method includes, based on a success of accessing the AP device in accordance with the attempt using the first network information, transmitting, to the server device, via the first communication circuitry, a second message representing that the first network information is available for an access to the AP device. The method includes, based on a failure of accessing the AP device in accordance with the attempt using the first network information, obtaining second network information for accessing the AP device or another AP device. The method includes, based on a success of accessing the AP device or the another AP device using the second network information, transmitting, to the IoT device registered in the server device, via the first communication circuitry or the second communication circuitry, the second network information.

In accordance with another aspect of the disclosure, a non-transitory computer readable storage medium is provided. The non-transitory computer readable storage media stores one or more programs including instructions, when executed by an electronic device including first communication circuitry and second communication circuitry, that cause the electronic device to receive, from a server device, via the first communication circuitry, a first message representing that a network connection problem occurred in association with an access point (AP) device. One or more IoT devices are registered in the server device in association with the electronic device. The non-transitory computer readable storage medium stores the one or more programs including the instructions, when executed by the electronic device, that cause the electronic device to, based on receiving the first message, attempt to access the access point (AP) device, using first network information included in the first message. The first network information is used by the one or more IoT devices for accessing the AP device. The non-transitory computer readable storage medium stores the one or more programs including the instructions, when executed by the electronic device, that cause the electronic device to, based on a success of accessing the AP device in accordance with the attempt using the first network information, transmit, to the server device, via the first communication circuitry, a second message representing that the first network information is available for an access to the AP device. The non-transitory computer readable storage medium stores the one or more programs including the instructions, when executed by the electronic device, that cause the electronic device to, based on a failure of accessing the AP device in accordance with the attempt using the first network information, obtain second network information for accessing the AP device or another AP device. The non-transitory computer readable storage medium stores the one or more programs including the instructions, when executed by the electronic device, that cause the electronic device to, based on a success of accessing the AP device or the another AP device using the second network information, transmit, to the IoT device registered in the server device, via the first communication circuitry or the second communication circuitry, the second network information.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1A illustrates Internet of Things (IoT) devices connected to a server based on access to a router according to an embodiment of the disclosure;

FIG. 1B illustrates a status in which a service set identifier (SSID) and a password of a router that one or more IoT devices access are changed for connecting to a server according to an embodiment of the disclosure;

FIG. 1C illustrates one or more IoT devices accessing a router using information transmitted from an electronic device according to an embodiment of the disclosure;

FIG. 2 illustrates a schematic view of an electronic device, a first external electronic device, a second external electronic device, and a server according to an embodiment of the disclosure;

FIG. 3 is a flowchart illustrating an operation performed in an electronic device in order to attempt to access a second external electronic device using first network information according to an embodiment of the disclosure;

FIG. 4 is a flowchart illustrating an operation of an electronic device for attempting to access a second external electronic device using fourth network information, based on a failure of accessing the second external electronic device using third network information which was used by a first external electronic device according to an embodiment of the disclosure;

FIG. 5A is a flowchart illustrating an operation of an electronic device for attempting to access a second external electronic device in accordance with a first external electronic device positioned in a reference region defined from the electronic device according to an embodiment of the disclosure;

FIG. 5B illustrates an operation of an electronic device for identifying that a first external electronic device is positioned in a reference region defined from the electronic device according to an embodiment of the disclosure;

FIG. 6 is a flowchart illustrating an operation of an electronic device for identifying whether a service set identifier (SSID), a password, and a frequency band in first network information are available according to an embodiment of the disclosure;

FIG. 7 is a flowchart illustrating an operation of an electronic device for transmitting obtained second network information to a first external electronic device after obtaining the second network information according to an embodiment of the disclosure;

FIG. 8A illustrates an operation of an electronic device for transmitting first network information to a first external electronic device according to an embodiment of the disclosure;

FIG. 8B illustrates an operation of an electronic device for transmitting second network information to a first external electronic device according to an embodiment of the disclosure;

FIG. 9A illustrates another operation of an electronic device for transmitting first network information to a first external electronic device according to an embodiment of the disclosure;

FIG. 9B illustrates another operation of an electronic device for transmitting second network information to a first external electronic device according to an embodiment of the disclosure;

FIG. 10 illustrates a screen displayed in an electronic device to obtain second network information when accessing a second external electronic device using first network information fails according to an embodiment of the disclosure;

FIG. 11 illustrates a screen displayed in an electronic device to represent that a first external electronic device is connected to a server using second network information according to an embodiment of the disclosure; and

FIG. 12 is a block diagram of an electronic device in a network environment according to various embodiments.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, in the disclosure, the term ‘greater than’ or ‘less than’ may be used to determine whether a particular condition is satisfied or fulfilled, but this is only a description to express an example and does not exclude description of 'greater than or equal to' or 'less than or equal to'. A condition described as 'greater than or equal to ' may be replaced with 'greater than', a condition described as 'less than or equal to' may be replaced with 'less than', and a condition described as ' greater than or equal to and less than' may be replaced with 'greater than and less than or equal to'. In addition, hereinafter, 'A' to 'B' refers to at least one of elements from A (including A) to B (including B).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

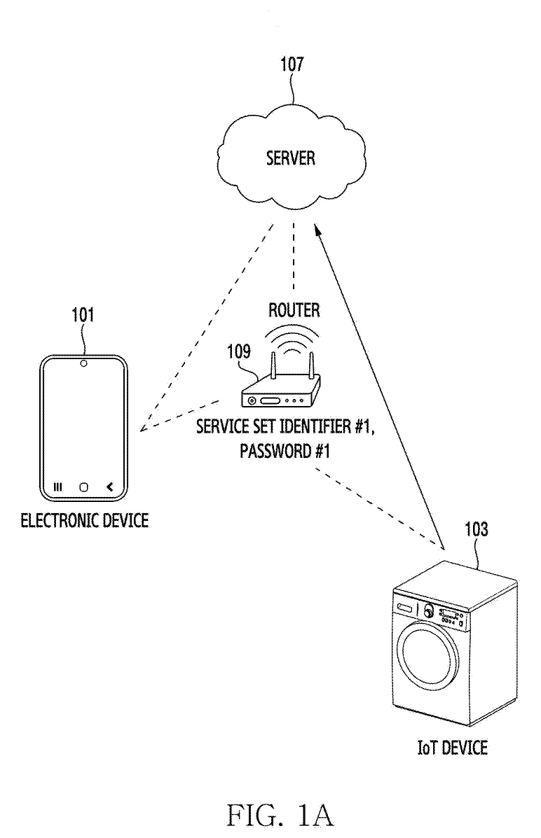

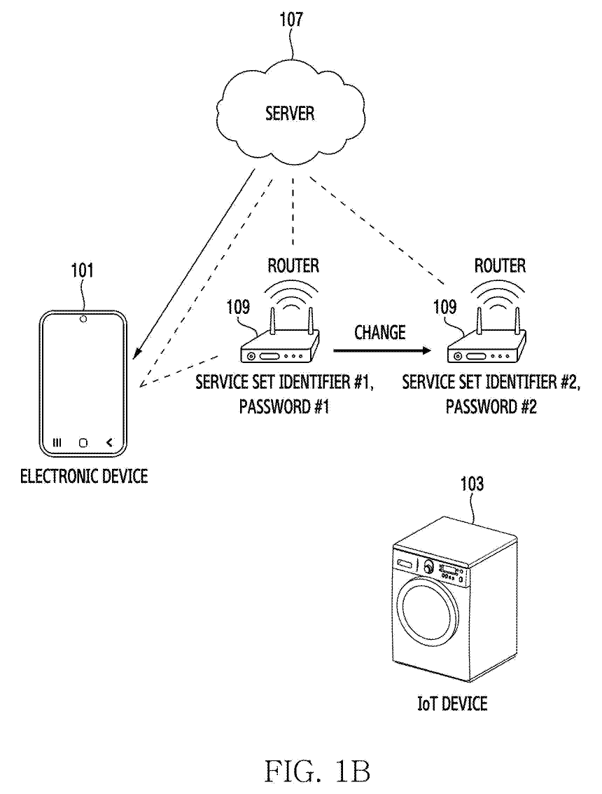

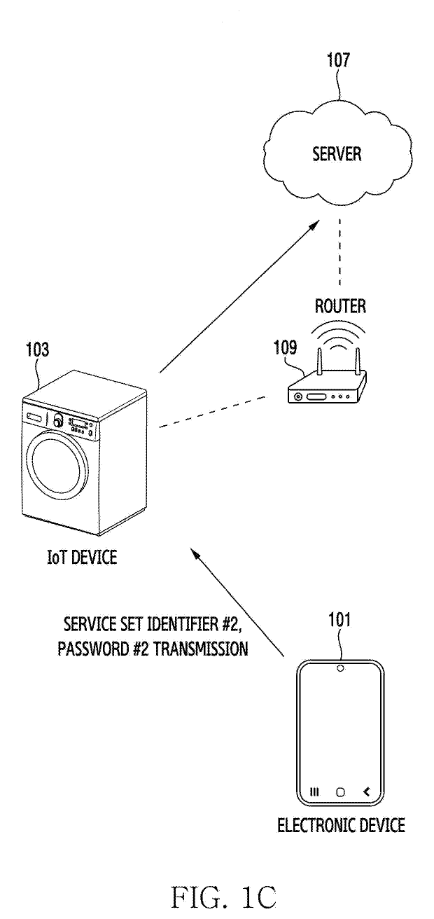

FIG. 1A illustrates Internet of Things (IoT) devices connected to a server based on access to a router according to an embodiment of the disclosure.

Referring to FIG. 1A, an IoT device 103 may be registered in a server 107. As a non-limiting example, the IoT device 103 may be referred to as a washing machine, and the server 107 may be referred to as a cloud server. For example, the cloud server may be described as a computer server accessible through the Internet. For example, the IoT device 103 may access a router 109. For example, the IoT device 103 may access the router 109 using a service set identifier #1 and a password #1 of a wireless network provided by the router 109. The router 109 may be used for a connection between the IoT device 103 and the server 107. For example, the IoT device 103 may be connected to the server 107 by accessing the Internet through the wireless network provided by the router 109. After the IoT device 103 is connected to the server 107, the IoT device 103 may transmit, to the server 107, a request for registration to the server 107. As the server 107 receives the request, the IoT device 103 may be registered in the server 107.

The IoT device 103 registered in the server 107 may be controlled by an electronic device 101. The electronic device 101 may be referred to as a smartphone. For example, the electronic device 101 may control the IoT device 103 based on a connection with the server 107. For example, the electronic device 101 may access the router 109 using the service set identifier #1 and the password #1 of the wireless network provided by the router 109. The electronic device 101 may be connected to the server 107 by accessing the Internet through the wireless network provided by the router 109. As a non-limiting example, the electronic device 101 may be connected to the server 107 without using the router 109. For example, the electronic device 101 may be connected to the server 107 by accessing the Internet using a cellular network in addition to the wireless network provided by the router 109. For example, the cellular network may include a network for long term evolution (LTE) and 5th generation (5G) new radio (NR) communication.

In order for the electronic device 101 to control the IoT device 103 registered in the server 107, a software application installed in the electronic device 101 may be used. The software application may be described as a software application used to control another electronic device (e.g., the IoT device 103) registered in the server 107 to be linked to the electronic device 101, and/or to identify a status of the other electronic device. The software application may identify the status of the other electronic device or control the other electronic device based on a connection with the other electronic device registered in the server 107 to be linked to the electronic device 101. For example, the software application may be referred to as a smart things application. For example, the electronic device 101 may transmit a signal for controlling the IoT device 103 to the server 107 while the software application is being executed. For example, the signal may include a signal for terminating power of the IoT device 103. The server 107 may transmit the signal to the IoT device 103 after receiving the signal transmitted from the electronic device 101. The IoT device 103 may be controlled by electronic device 101 based on receiving the signal. For example, the power of the IoT device 103 may be terminated based on the signal being received.

In a case that the access of the IoT device 103 to the router 109 is disconnected, it may be impossible to control the IoT device 103 using the electronic device 101. An example of a situation in which it is impossible to control the IoT device 103 using the electronic device 101 will be described with reference to FIG. 1B.

FIG. 1B illustrates a status in which a service set identifier (SSID) and a password of a router that one or more IoT devices access are changed for connecting to a server according to an embodiment of the disclosure.

Referring to FIG. 1B, in a case that the access of the IoT device 103 to the router 109 becomes impossible, it may be impossible to control the IoT device 103 using the electronic device 101. For example, in a case that the access of the IoT device 103 to the router 109 is impossible, it may be impossible for the IoT device 103 to access the wireless network provided by the router 109. In a case that it is impossible for the IoT device 103 to access the wireless network, it may be impossible for the IoT device 103 to be connected to the server 107. In a case that it is impossible for the IoT device 103 to be connected to the server 107, it may be impossible for the server 107 to deliver a signal that the electronic device 101 has transmitted to the server for controlling the IoT device 103, to the IoT device 103. For example, the electronic device 101 may transmit a signal for controlling the IoT device 103 registered in the server 107 to the server 107. The server 107 may receive the signal for controlling the IoT device 103. In a case that it is impossible for the IoT device 103 to be connected to the server 107, it may be impossible for the server 107 to transmit the signal for controlling the IoT device 103 to the IoT device 103. It is impossible for the IoT device 103 to receive the signal for controlling the IoT device 103 from the server 107. As it is impossible for the IoT device 103 to receive the signal from the server 107, it may become impossible for the electronic device 101 to control the IoT device 103.

In a case that a service set identifier and/or a password for accessing the router 109 is changed, it may be impossible for the IoT device 103 to access the router 109. For example, in a case that the service set identifier for accessing the router 109 is changed from the service set identifier #1, which has been stored in the IoT device 103, to a service set identifier #2, it may be impossible for the IoT device 103 to access the router 109. For example, in a case that the password for accessing the router 109 is changed from the password #1, which has been stored in the IoT device 103, to a password #2, it may be impossible for the IoT device 103 to access the router 109.

In a case that the service set identifier for accessing the router 109 is changed from the service set identifier #1 to the service set identifier #2, and the password for accessing the router 109 is changed from the password #1 to the password #2, it may be impossible for the IoT device 103 to access the router 109. For example, the service set identifier for accessing the router 109 being changed from the service set identifier #1 to the service set identifier #2 and/or the password for accessing the router 109 being changed from the password #1 to the password #2 may occur in accordance with a change of a setting of the router 109. For example, the service set identifier for accessing the router 109 being changed from the service set identifier #1 to the service set identifier #2 and/or the password for accessing the router 109 being changed from the password #1 to the password #2 may occur in accordance with a change of a device of the router 109 in an environment including the electronic device 101 and the IoT device 103.

In a case that the IoT device 103 accesses the router 109 again, the electronic device 101 may control the IoT device 103 using the software application installed in the electronic device 101. An example of a case where the IoT device 103 is reconnected to the router 109 will be described below with reference to FIG. 1C.

FIG. 1C illustrates one or more IoT devices accessing a router using information transmitted from an electronic device according to an embodiment of the disclosure.

Referring to FIG. 1C, the electronic device 101 may transmit the service set identifier #2 and the password #2 to the IoT device 103 to assist the IoT device 103 to access the router 109. The IoT device 103 may receive the service set identifier #2 and the password #2 transmitted from the electronic device 101, respectively. The IoT device 103 may access the router 109 using the service set identifier #2 and the password #2 that are received. In a case that the IoT device 103 accesses the router 109, the IoT device 103 may access the wireless network provided by the router 109. The IoT device 103 may be connected to the server 107 by accessing the Internet through the wireless network. As described above in FIG. 1A, the IoT device 103 connected to the server 107 may be controlled by the electronic device 101.

In order for the electronic device 101 to transmit the service set identifier #2 and the password #2 to the IoT device 103, the electronic device 101 may obtain the service set identifier #2 and the password #2 from a user. For example, the electronic device 101 may obtain the service set identifier #2 and the password #2 by identifying an input received from the user. The electronic device 101 may assist the IoT device 103 to access the router 109 by transmitting the service set identifier #2 and the password #2 that are obtained to the IoT device 103.

The above-described operations may cause inconvenience to the user of the electronic device 101 and the IoT device 103. For example, in a case that the electronic device 101 has performed accessing the router 109 by using the service set identifier #2 and the password #2, re-entering the service set identifier #2 and the password #2 through the software application executed in the electronic device 101 for the IoT device 103 to access the router 109 may cause inconvenience to the user. In order to reduce the user's inconvenience, a method for simplifying the operations may be provided below.

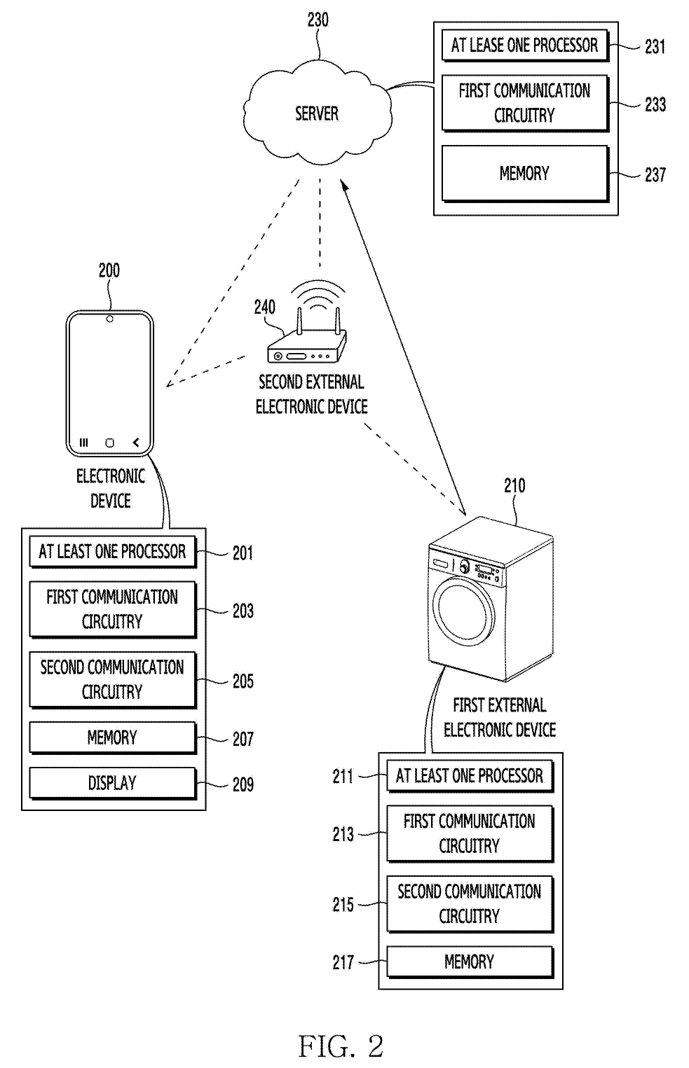

FIG. 2 illustrates a schematic view of an electronic device, a first external electronic device, a second external electronic device, and a server according to an embodiment of the disclosure.

Referring to FIG. 2, FIG. 2 may include an electronic device 200, a first external electronic device 210, a second external electronic device 240, and a server 230.

The first external electronic device 210 may be registered in the server 230. The first external electronic device 210 may be described as an IoT device. As an example, the first external electronic device 210 may be referred to as a washing machine. The server 230 may be referred to as a cloud server. The second external electronic device 240 may be referred to as a router or an AP device. The server 230 may be referred to as a server device 230. For example, the first external electronic device 210 may access the second external electronic device 240. The second external electronic device 240 may be used for a connection between the first external electronic device 210 and the server 230. For example, the first external electronic device 210 may be connected to the server 230 in the Internet by accessing the Internet through a wireless network provided by the second external electronic device 240. After the first external electronic device 210 is connected to the server 230, the first external electronic device 210 may transmit, to the server 230, a request for registration to the server 230. As the server 230 receives the request, the first external electronic device 210 may be registered in the server 230.

The electronic device 200 may control the first external electronic device 210 registered in the server 230 in association with the electronic device 200 through a software application installed in the electronic device 200. The software application may be described as a software application used to control another electronic device (e.g., the first external electronic device 210) registered in the server 230 to be linked to the electronic device 200, and/or to identify a status of the other electronic device. The software application may identify the status of the other electronic device or control the other electronic device based on a connection with the other electronic device registered in the server 230 to be linked to the electronic device 200. For example, the software application may be referred to as a smart things application. For example, the electronic device 200 may transmit a signal for controlling the first external electronic device 210 to the server 230 while the software application is being executed. As an example, the signal may include a signal for terminating power of the first external electronic device 210. The first external electronic device 210 may be controlled by the electronic device 200 based on receiving the signal. For example, the power of the first external electronic device 210 may be terminated based on the signal being received.

The first external electronic device 210 connected to the server 230 may periodically transmit a signal related to an operation of the first external electronic device 210 to the server 230. As a non-limiting example, the signal related to the operation of the first external electronic device 210 referred to as the washing machine may include a signal representing time remaining until washing is completed. As a non-limiting example, the signal related to the operation of the first external electronic device 210 may include a signal representing a temperature of water used when the first external electronic device 210 performs washing. As a non-limiting example, the signal related to the operation of the first external electronic device 210 may be described as a signal that is periodically transmitted from the first external electronic device 210 to the server 230 to represent (notify) to the server 230 that the first external electronic device 210 is in a status capable of being connected to the server 230.

The server 230 may periodically receive the signal transmitted from the first external electronic device 210. The server 230 may identify that a status of the first external electronic device 210 is the status capable of being connected to the server 230 by periodically receiving the signal.

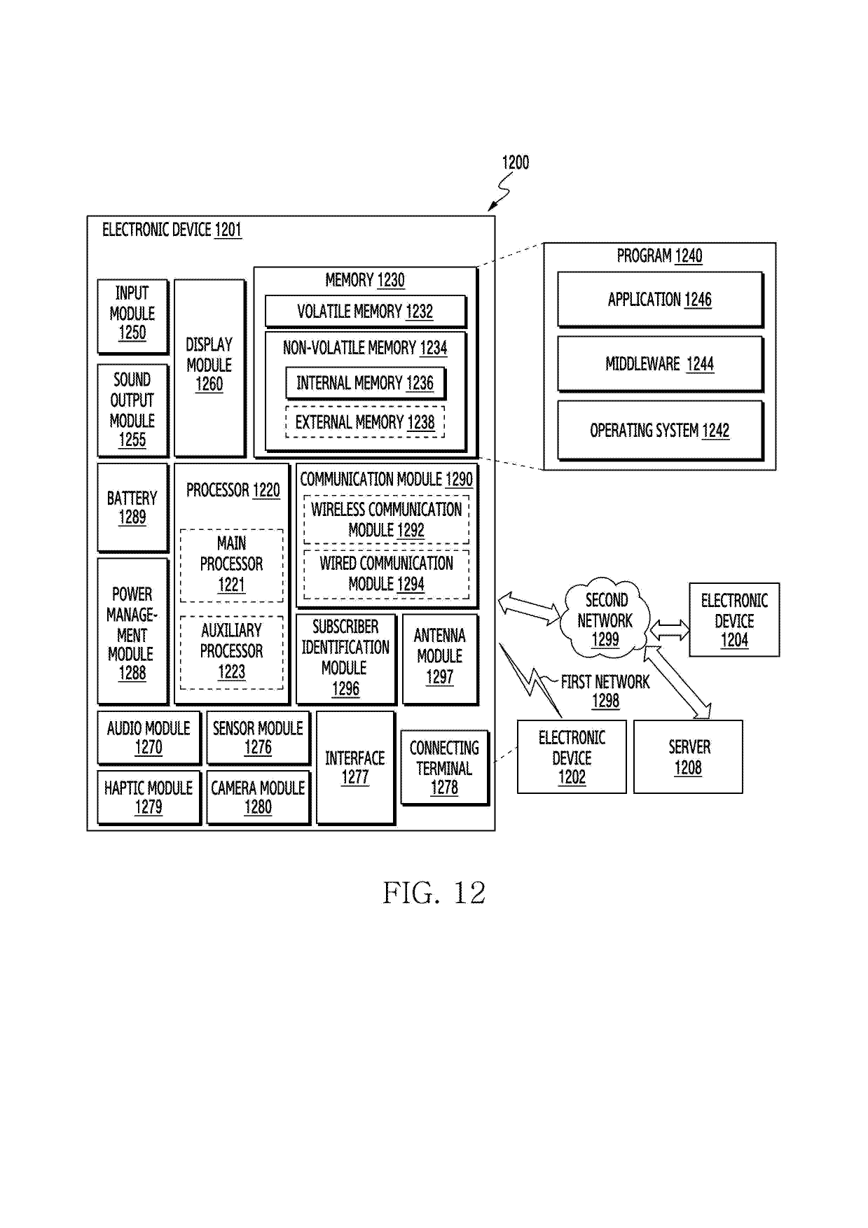

The electronic device 200 may include at least one processor 201, first communication circuitry 203, second communication circuitry 205, memory 207, and a display 209. The components (e.g., the at least one processor 201, the first communication circuitry 203, the second communication circuitry 205, the memory 207, and the display 209) are among different components that may be used. For example, the electronic device 200 may include other components (e.g., power management integrated circuitry (PMIC)). For example, some components may be omitted from the electronic device 200. The electronic device 200 of FIG. 2 may be an example of an electronic device 1201 of FIG. 12.

The at least one processor 201 may be implemented with one or more integrated circuitry (IC) chips and may execute various data processes. The at least one processor 201 may include at least one electrical circuitry and may individually or collectively perform distributed processing of instructions (or programs or data) stored in the memory 207. The at least one processor 201 may include a processor assembly including one or more processing circuits. The at least one processor 201 may include any processing circuitry that is operational to control a performance and operations of one or more components (e.g., the memory 207 and/or the display 209) of the electronic device 200. For example, the at least one processor 201 (e.g., an application processor (AP)) may be implemented as a system on chip (SoC) (e.g., one chip or one chip set). For example, the at least one processor 201 may be implemented with multiple cores (or multiple core circuits), multiple chips, or multiple chip sets. For example, the at least one processor 201 may include one or more processing circuits configured to individually and/or collectively perform various functions of the disclosure.

For example, the at least one processor 201 may include a central processing unit (CPU) (e.g., including processing circuitry) and a graphics processing unit (GPU) (e.g., including processing circuitry). Components (e.g., the CPU and the GPU) of the at least one processor 201 are among different components that may be used. The at least one processor 201 of FIG. 2 may be an example of a processor 1220 of FIG. 12.

The first communication circuitry 203 of the electronic device 200 may include hardware for supporting transmission and/or reception of signals between the electronic device 200, the first external electronic device 210, and the server 230. The first communication circuitry 203 may include, for example, at least one of MODEM, an antenna, and an optic/electronic (O/E) converter. The first communication circuitry 203 may support transmission and/or reception of signals based on various types of communication means such as Ethernet, ZigBee, long term evolution (LTE), 5G new radio (NR), and wireless fidelity (Wi-Fi). The first communication circuitry 203 of FIG. 2 may be an example of a communication module 1290 of FIG. 12.

The second communication circuitry 205 of the electronic device 200 may include hardware for supporting transmission and/or reception of signals between the electronic device 200 and the first external electronic device 210. The second communication circuitry 205 may include, for example, at least one of MODEM, an antenna, and an optic/electronic (O/E) converter. The second communication circuitry 205 may support transmission and/or reception of signals based on various types of communication means such as Bluetooth and Bluetooth Low Energy (BLE). The second communication circuitry 205 of FIG. 2 may be an example of the communication module 1290 of FIG. 12.

The memory 207 of the electronic device 200 may include a hardware component for storing data and/or instructions inputted into the at least one processor 201 and/or outputted from the at least one processor 201. The memory may include, for example, volatile memory such as random-access memory (RAM), and/or non-volatile memory such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (eMMC).

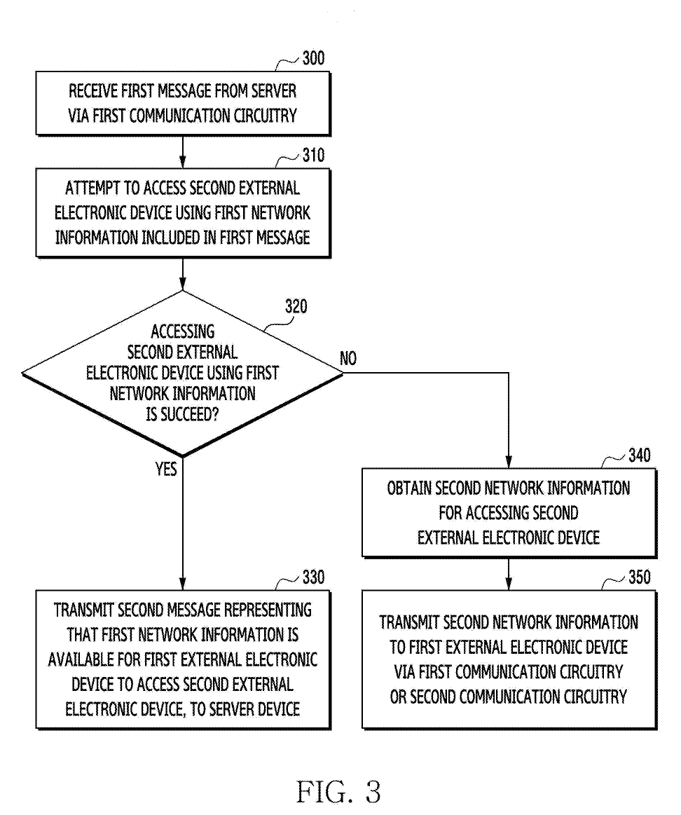

One or more instructions (or commands) representing a computation and/or an operation to be performed by the at least one processor 201 of the electronic device 200 may be stored in the memory 207 of the electronic device 200. A set of one or more instructions may be referred to as a program, firmware, an operating system, a process, a routine, a sub-routine and/or an application. Hereinafter, an application being installed in an electronic device (e.g., the electronic device 200) may mean that one or more instructions provided in a form of an application are stored in the memory 207, and that the one or more applications are stored in an executable format (e.g., a file with an extension designated by an operating system of the electronic device 200) by a processor of the electronic device. The electronic device 200 may perform operations of FIGS. 3, 4, 5A, 5B, 6, 7, 8A, 8B, 9A, and 9B by executing one or more instructions stored in the memory 207. For example, the one or more instructions may cause, when executed by the at least one processor 201, the electronic device 200 to perform at least a portion of the operations of FIGS. 3, 4, 5A, 5B, 6, 7, 8A, 8B, 9A, and 9B. The memory 207 of FIG. 2 may be an example of memory 1230 of FIG. 12.

The display 209 of the electronic device 200 may output visualized information to a user of the electronic device 200. For example, the display 209 may be controlled by the at least one processor 201 including circuitry such as CPU and/or a graphics processing unit (GPU) to output visualized information to the user. The at least one processor 201 may receive an input from the user through the display 209 of the electronic device 200. The at least one processor 201 may identify the input received from the user. The display 209 of FIG. 2 may be an example of a display module 1260 of FIG. 12.

The first external electronic device 210 may include at least one processor 211, first communication circuitry 213, second communication circuitry 215, and memory 217. The components (e.g., the at least one processor 211, the first communication circuitry 213, the second communication circuitry 215, and the memory 217) are among different components that may be used. For example, the first external electronic device (210) may include other components (e.g., power management integrated circuitry (PMIC)). For example, some components may be omitted from the first external electronic device 210. The first external electronic device 210 of FIG. 2 may be an example of an electronic device 1202 or 1204 of FIG. 12.

The at least one processor 211 may be implemented with one or more integrated circuitry (IC) chips and may execute various data processes. The at least one processor 211 may include at least one electrical circuitry and may individually or collectively perform distributed processing of instructions (or program, data) stored in the memory 217. The at least one processor 211 may include a processor assembly including one or more processing circuits. The at least one processor 211 may include any processing circuitry that is operational to control a performance and operations of one or more components (e.g., the memory 217, the first communication circuitry 213 and/or the second communication circuitry 215) of the first external electronic device 210. For example, the at least one processor 211 (e.g., an application processor (AP)) may be implemented as a system on chip (SoC) (e.g., one chip or one chip set). For example, the at least one processor 211 may be implemented with multiple cores (or multiple core circuits), multiple chips, or multiple chip sets. For example, the at least one processor 211 may include one or more processing circuits configured to individually and/or collectively perform various functions of the disclosure. For example, at least one processor 211 may include a central processing unit (CPU) (e.g., including processing circuitry) and a graphics processing unit (GPU) (e.g., including processing circuitry). Components (e.g., the CPU and the GPU) of the at least one processor 211 are among different components that may be used. The at least one processor 211 of FIG. 2 may be an example of the processor 1220 of FIG. 12.

The first communication circuitry 213 of the first external electronic device 210 may include hardware for supporting transmission and/or reception of signals between the electronic device 200 and the server 230, and the first external electronic device 210. The first communication circuitry 213 may include, for example, at least one of MODEM, an antenna, and an optic/electronic (O/E) converter. The first communication circuitry 213 may support transmission and/or reception of signals based on various types of communication means such as Ethernet, ZigBee, long term evolution (LTE), 5G new radio (NR), and wireless fidelity (Wi-Fi). The first communication circuitry 213 of FIG. 2 may be an example of the communication module 1290 of FIG. 12.

The second communication circuitry 215 of the first external electronic device 210 may include hardware for supporting transmission and/or reception of signals between the electronic device 200 and the first external electronic device 210. The second communication circuitry 215 may include, for example, at least one of MODEM, an antenna, and an optic/electronic (O/E) converter. The second communication circuitry 215 may support transmission and/or reception of signals based on various types of communication means such as Bluetooth and Bluetooth low energy (BLE). The second communication circuitry 215 of FIG. 2 may be an example of the communication module 1290 of FIG. 12.

The memory 217 of the first external electronic device 210 may include a hardware component for storing data and/or instructions inputted into the at least one processor 211 and/or outputted from the at least one processor 211. The memory may include, for example, volatile memory such as random-access memory (RAM), and/or non-volatile memory such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (eMMC).

One or more instructions (or commands) representing a computation and/or an operation to be performed by the at least one processor 211 of the first external electronic device 210 may be stored in the memory 217 of the first external electronic device 210. A set of one or more instructions may be referred to as a program, firmware, an operating system, a process, a routine, a sub-routine and/or an application. Hereinafter, an application being installed in another electronic device (e.g., the first external electronic device 210) may mean that one or more instructions provided in a form of an application are stored in the memory 217, and that the one or more applications are stored in an executable format (e.g., a file with an extension designated by an operating system of the first external electronic device 210) by the processor of the electronic device. The first external electronic device 210 may perform an operation by executing the one or more instructions stored in the memory 217. The memory 217 of FIG. 2 may be an example of the memory 1230 of FIG. 12.

As a non-limiting example, the first external electronic device 210 may include a display having a relatively small size, or may not include a display. For example, in a case that a connection of the first external electronic device 210 to the second external electronic device 240 is impossible due to a change in network information (e.g., a change in a service set identifier and/or a change in a password) of the second external electronic device 240, since the first external electronic device 210 includes a display having a relatively small size or does not include a display, it may be substantially impossible for the first external electronic device 210 to change the network information of the second external electronic device 240 stored in the first external electronic device 210 in accordance with an input received with respect to the first external electronic device 210. Since it is substantially impossible for the first external electronic device 210 to change the network information of the second external electronic device 240 stored in the first external electronic device 210 in accordance with the input, the first external electronic device 210 may access the second external electronic device 240, based on receiving information for the connection to the second external electronic device 240, transmitted from the electronic device 200 through a software application (e.g., the smart things application) executed in the electronic device 200. However, the disclosure is not limited thereto. The first external electronic device 210 may include a display.

The server 230 may include at least one processor 231, first communication circuitry 233, and memory 237. The components (e.g., the at least one processor 231, the first communication circuitry 233, and the memory 237) are among different components that may be used. For example, the server 230 may include other components (e.g., power management integrated circuitry (PMIC)). For example, some components may be omitted from the server 230. The server 230 may be referred to as a cloud server. The server 230 of FIG. 2 may be an example of a server 1208 of FIG. 12.

The at least one processor 231 may be implemented with one or more integrated circuitry (IC) chips and may execute various data processes. The at least one processor 231 may include at least one electrical circuitry and may individually or collectively perform distributed processing of instructions (or programs or data) stored in the memory 237. The at least one processor 231 may include a processor assembly including one or more processing circuits. The at least one processor 231 may include any processing circuitry that is operational to control a performance and operations of one or more components (e.g., the memory 237 and/or the first communication circuitry 233) of the server 230. For example, the at least one processor 231 (e.g., an application processor (AP)) may be implemented as a system on chip (SoC) (e.g., one chip or one chip set). For example, the at least one processor 231 may be implemented with multiple cores (or multiple core circuits), multiple chips, or multiple chip sets. For example, the at least one processor 231 may include one or more processing circuits configured to individually and/or collectively perform various functions of the disclosure. For example, the at least one processor 231 may include a central processing unit (CPU) (e.g., including processing circuitry) and a graphics processing unit (GPU) (e.g., including processing circuitry). Components (e.g., the CPU and the GPU) of the at least one processor 231 are among different components that may be used. The at least one processor 231 of FIG. 2 may be an example of the processor 1220 of FIG. 12.

The first communication circuitry 233 of the server 230 may include hardware for supporting transmission and/or reception of signals between the electronic device 200, the first external electronic device 210, and the server 230. The first communication circuitry 233 may include, for example, at least one of MODEM, an antenna, and an optic/electronic (O/E) converter. The first communication circuitry 233 may support transmission and/or reception of signals based on various types of communication means such as Ethernet, ZigBee, long term evolution (LTE), 5G new radio (NR), and wireless fidelity (Wi-Fi). The first communication circuitry 233 of FIG. 2 may be an example of the communication module 1290 of FIG. 12.

The memory 237 of the server 230 may include a hardware component for storing data and/or instructions inputted into the at least one processor 231 and/or outputted from the at least one processor 231. The memory may include, for example, volatile memory such as random-access memory (RAM), and/or non-volatile memory such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (eMMC).

One or more instructions (or commands) representing a computation and/or an operation to be performed by the at least one processor 231 of the server 230 may be stored in the memory 237 of the server 230. A set of one or more instructions may be referred to as a program, firmware, an operating system, a process, a routine, a sub-routine and/or an application. Hereinafter, an application being installed in another electronic device (e.g., the server 230) may mean that one or more instructions provided in a form of an application are stored in the memory 237, and that the one or more applications are stored in an executable format (e.g., a file with an extension designated by an operating system of the server 230) by the processor of the electronic device. The server 230 may perform an operation by executing the one or more instructions stored in the memory 237. The memory 237 of FIG. 2 may be an example of the memory 1230 of FIG. 12.

The second external electronic device 240 may provide a wireless network to the electronic device 200 and the first external electronic device 210. The electronic device 200 and the first external electronic device 210 may access the wireless network provided by the second external electronic device 240, by accessing the second external electronic device 240. The electronic device 200 and the first external electronic device 210 may access the Internet through the wireless network provided by the second external electronic device 240. The electronic device 200 and the first external electronic device 210 may be connected to the server 230 through the Internet. For example, the wireless network may include wireless fidelity (Wi-Fi). In order for the electronic device 200 and the first external electronic device 210 to access the second external electronic device 240, a service set identifier (SSID) and a password may be used. The service set identifier and password may be referred to as access point (AP) information or network information.

In a case that the network information used for accessing the second external electronic device 240 is changed, a connection of the first external electronic device 210 to the server 230 may be disconnected (or cut off). For example, in a case that the service set identifier or the password used for accessing the second external electronic device 240 is changed, the connection of the first external electronic device 210 to the server 230 may be disconnected (or cut off). As an example, the service set identifier used for accessing the second external electronic device 240 may be a first service set identifier. As the first service set identifier is changed to a second service set identifier, the connection of the first external electronic device 210 to the server 230 may be disconnected (or cut off). As an example, the password used for accessing the second external electronic device 240 may be a first password. As the first password is changed to a second password, the connection of the first external electronic device 210 to the server 230 may be disconnected (or cut off). For example, as the second external electronic device 240 is changed to another router (or another AP device), both the service set identifier and the password used by the first external electronic device 210 for accessing the second external electronic device 240 may be changed. In a case that both the service set identifier and the password are changed, the connection of the first external electronic device 210 to the server 230 may be disconnected (or cut off).

The connection of the first external electronic device 210 to the server 230 being disconnected may represent that a connection status of the first external electronic device 210 is in an offline status. In a case that the connection status of the first external electronic device 210 is in the offline status, it may be impossible for the electronic device 200 to control the first external electronic device 210. For example, the server 230 may receive a control command for controlling the first external electronic device 210, transmitted from the electronic device 200, from the electronic device 200 through the first communication circuitry 233. After transmitting a request signal including the control command to the first external electronic device 210, the server 230 may activate a timer for receiving a response signal with respect to the request signal from the first external electronic device 210. As an example, the server 230 may determine time required to receive the response signal by activating the timer after transmitting the request signal to the first external electronic device 210. The server 230 may identify that the connection status of the first external electronic device 210 to the server 230 is the offline status based on the response signal being not received until expiration of the timer. In a case that the connection status of the first external electronic device 210 to the server 230 is the offline status, as the control command is not received to the first external electronic device 210, it may be impossible for the electronic device 200 to control the first external electronic device 210.

Based on identifying that the connection status of the first external electronic device 210 is the offline status, the server 230 may identify the second external electronic device 240, registered with respect to a place in which the first external electronic device 210 is positioned, to which the first external electronic device 210 was accessed for a connection with the server 230. Based on identifying the second external electronic device 240 to which the first external electronic device 210 was accessed, the server 230 may identify one or more other external electronic devices (or other IoT devices) that accessed the second external electronic device 240. The server 230 may identify a connection status of the one or more other external electronic devices that accessed the second external electronic device 240. For example, the server 230 may transmit signals for checking the connection status to the one or more other external electronic devices, and activate a timer. The server 230 may identify that the connection status of the one or more other external electronic devices is an offline status, based on response signals with respect to the signals for checking the connection status being not received until expiration of the timer. That is, the server 230 may identify that a connection of the one or more other external electronic devices to the second external electronic device 240 is disconnected based on the response signals not being received from the one or more other external electronic devices.

The server 230 may transmit a first message representing that a network connection problem occurred in association with the second external electronic device 240, based on a connection status of the first external electronic device 210 and the one or more other external electronic devices that accessed the second external electronic device 240 being the offline status. The first message may include first network information used by the first external electronic device 210 and the other external electronic devices for accessing the second external electronic device 240. The electronic device 200 may perform operations of FIG. 3 below to diagnose the network connection problem in association with the second external electronic device 240 based on receiving the first message.

FIG. 3 is a flowchart illustrating an operation performed in an electronic device in order to attempt to access a second external electronic device using first network information according to an embodiment of the disclosure.

At least a portion of the methods of FIG. 3 may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 3, in operation 300, the at least one processor 201 may receive a first message from a server 230 via first communication circuitry 203. For example, the at least one processor 201 may receive the first message representing that a network connection problem occurred in association with a second external electronic device 240 from the server 230 through the first communication circuitry 203.

In a case that connecting to a server 230 using the second external electronic device 240 is available in a first external electronic device 210, the electronic device 200 may transmit a control command for controlling the first external electronic device 210 to the first external electronic device 210. For example, the electronic device 200 may transmit the control command to the server 230. The server 230 may transmit a request signal including the control command to the first external electronic device 210 based on receiving the control command. In accordance with receiving the request signal, the first external electronic device 210 may periodically transmit a signal related to an operation corresponding to the control command to the server 230. As a non-limiting example, in a case of the first external electronic device 210 referred to as a washing machine, the signal related to the operation corresponding to the control command may include a signal representing time remaining until washing is completed. As a non-limiting example, the signal related to the operation corresponding to the control command may include a signal representing a temperature of water used when the first external electronic device 210 performs washing. As a non-limiting example, the signal related to the operation of the first external electronic device 210 may be described as a signal that is periodically transmitted from the first external electronic device 210 to the server 230 to represent (notify) to the server 230 that the first external electronic device 210 is in a status capable of being connected to the server 230.

At least one processor 231 of the server 230 may periodically receive the signal related to the operation corresponding to the control command through first communication circuitry 233. The at least one processor 231 of the server 230 may identify that the first external electronic device 210 is capable of being connected to the server 230 by periodically receiving the signal. In a case that the signal is not periodically transmitted from the first external electronic device 210 to the server 230, the at least one processor 231 of the server 230 may determine that it is impossible for the first external electronic device 210 to connect to the server 230. For example, the server 230 may activate a timer for receiving a response signal with respect to the request signal. The server 230 may identify that a connection status of the first external electronic device 210 to the server 230 is an offline status, based on the response signal being not received until expiration of the timer.

In operation 300, an operation in which the server 230 identifies the offline status of the first external electronic device 210 may be equally applied to one or more other external electronic devices. For example, the electronic device 200 may transmit control commands for controlling the one or more other external electronic devices to the server 230. The server 230 may activate a timer after transmitting request signals including the control commands to the one or more other external electronic devices. The server 230 may identify that a connection status of the one or more other external electronic devices to the server 230 is an offline status, based on the response signals being not received until expiration of the timer.

The at least one processor 231 of the server 230 may transmit the first message to the electronic device 200 through the first communication circuitry 233 as it identifies that a state of the first external electronic device 210 and the one or more other external electronic devices that accessed the second external electronic device 240 is the offline status. The at least one processor 201 of the electronic device 200 may receive the first message from the server 230 through the first communication circuitry 203.

The at least one processor 201 of the electronic device 200 may perform the following operation 310 based on receiving the first message.

In operation 310, the at least one processor 201 may attempt to access the second external electronic device 240 using the first network information included in the first message. The first message may include a first service set identifier and a first password used by the first external electronic device 210 for accessing the second external electronic device 240. The at least one processor 201 of the electronic device 200 may attempt to access the second external electronic device 240 using the first service set identifier and the first password.

In operation 320, in a case that at least one processor 201 succeeds in accessing the second external electronic device 240 using the first network information, the at least one processor 201 may perform operation 330. For example, in a case that the at least one processor 201 succeeds in accessing the first external electronic device 210 using the first service set identifier and the first password, the at least one processor 201 may perform the operation 330. In a case that the at least one processor 201 succeeds in accessing the second external electronic device 240 using the first service set identifier and the first password in the first network information, the at least one processor 201 may determine that the first service set identifier and the first password in the first network information are available in the first external electronic device 210.

In contrast, in operation 320, in a case that the at least one processor 201 determines that accessing the second external electronic device 240 using the first network information fails, the at least one processor 201 may perform operation 340. For example, in a case that the at least one processor 201 fails to access the first external electronic device 210 using the first service set identifier and the first password, the at least one processor 201 may perform operation 340. In a case that the at least one processor 201 fails to access the second external electronic device 240 using the first service set identifier and the first password in the first network information, the at least one processor 201 may determine that the first service set identifier or the first password in the first network information is not available in the first external electronic device 210.

In operation 330, the at least one processor 201 may transmit a second message representing that the first network information is available for the first external electronic device 210 to access the second external electronic device 240, to the server device 230 through the first communication circuitry 203 or second communication circuitry 205. For example, the at least one processor 201 may transmit the second message representing that the first service set identifier and the first password used for accessing the second external electronic device 240 are not changed to the server device 230.

In operation 340, the at least one processor 201 may obtain second network information for accessing the second external electronic device 240. For example, the at least one processor 201 may obtain the second network information different from the first network information, based on determining that the first service set identifier or the first password in the first network information is not available in the first external electronic device 210. The second network information may include a second service set identifier and a second password. In a case that only the first service set identifier for accessing the second external electronic device 240 is changed, the second service set identifier may be different from the first service set identifier, and the second password may be the same as the first password. In a case that only the first password for accessing the second external electronic device 240 is changed, the second password may be different from the first password, and the second service set identifier may be the same as the first service set identifier. In a case that the second external electronic device 240 is changed (or replaced) to another AP device, the second service set identifier and the second password for accessing the other AP device may be different from the first service set identifier and the first password.

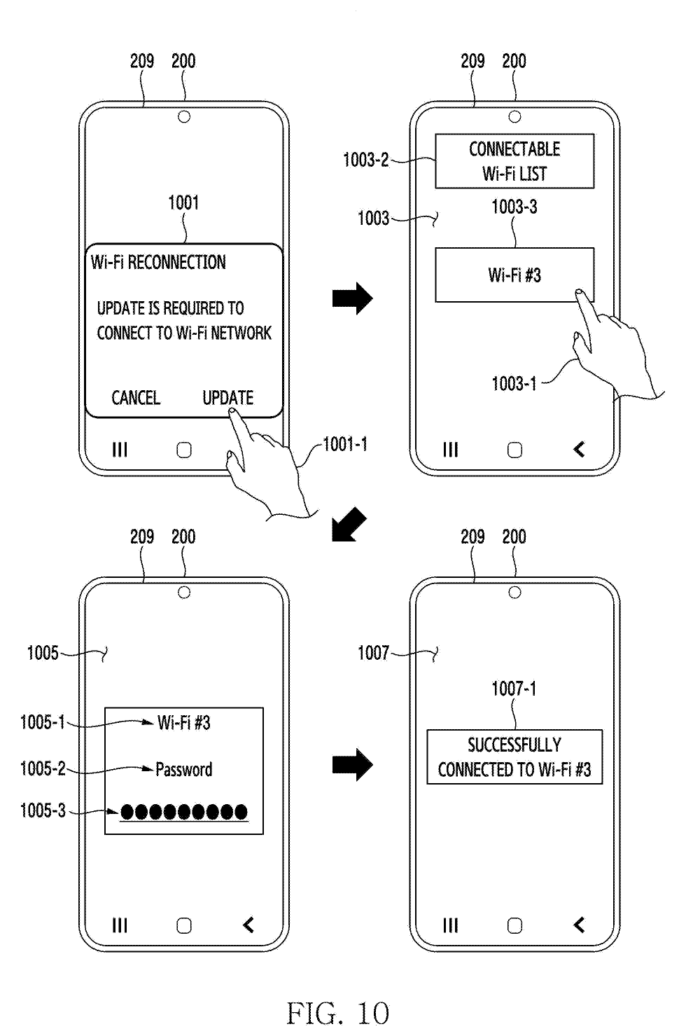

After obtaining the second network information, the at least one processor 201 may attempt to access the second external electronic device 240 or the other AP device using the obtained second network information. A specific example of a screen for obtaining the second network information will be described below with reference to FIG. 10.

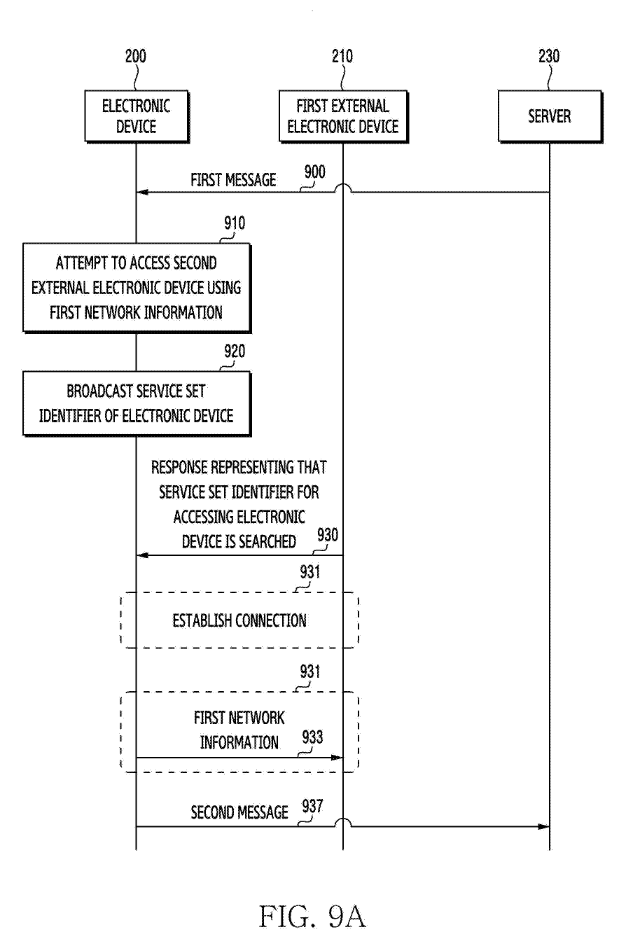

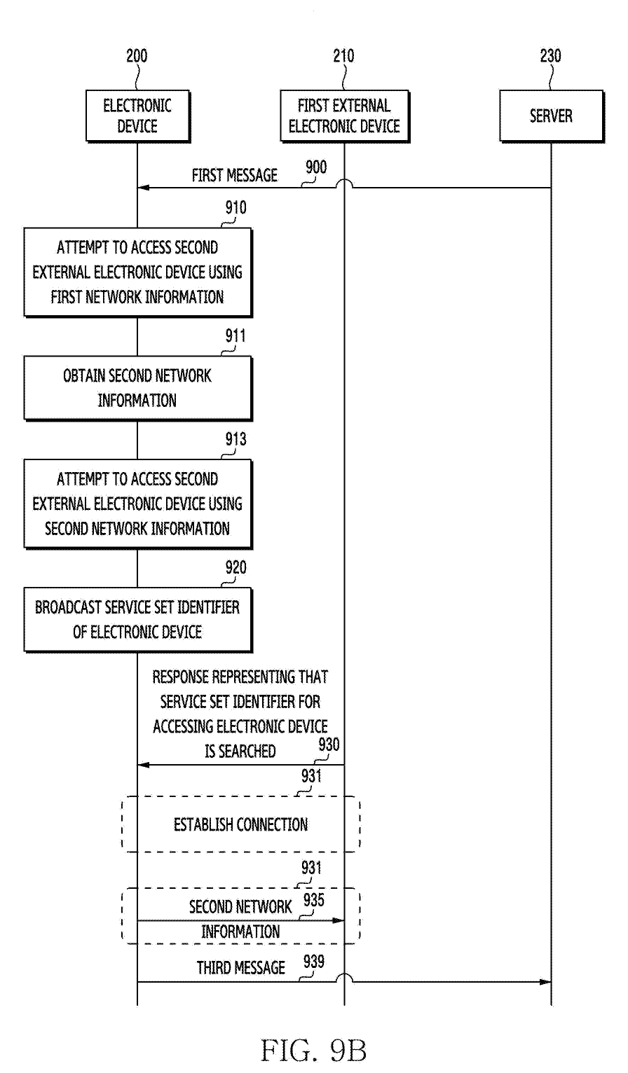

In operation 350, the at least one processor 201 may transmit the second network information to the first external electronic device 210 via the first communication circuitry 203 or the second communication circuitry 205. For example, the at least one processor 201 may transmit the second network information to the first external electronic device 210 through the first communication circuitry 203 or the second communication circuitry 205, based on a success of accessing the second external electronic device 240 or the other AP device using the second network information. For example, the at least one processor 201 may establish a connection with the first external electronic device 210 to transmit the second network information to the first external electronic device 210. For example, the first communication circuitry 203 or the second communication circuitry 205 may be used for the connection. A specific content regarding the connection will be described below with reference to FIGS. 9A and 9B.

As described above, the at least one processor 201 of the electronic device 200 may attempt to access the second external electronic device 240 using the first network information as it receives the first network information. The at least one processor 201 attempting to access the second external electronic device 240 using the first network information may be performed without receiving a separate input from a user. As the at least one processor 201 attempts to access the second external electronic device 240 without receiving the separate input from the user, the electronic device 200 may automatically diagnose a network problem associated with the second external electronic device 240.

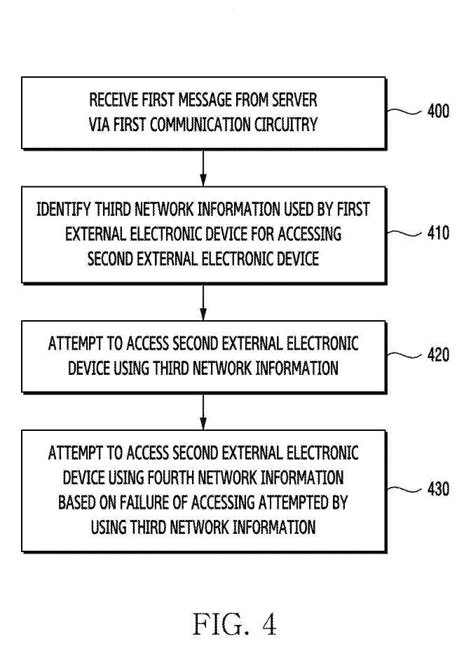

FIG. 4 is a flowchart illustrating an operation of an electronic device for attempting to access a second external electronic device using fourth network information, based on a failure of accessing the second external electronic device using third network information which was used by a first external electronic device according to an embodiment of the disclosure.

At least a portion of the methods of FIG. 4 may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 4, in operation 400, the at least one processor 201 may receive a first message from a server 230 via first communication circuitry 203. The operation 400 of FIG. 4 may correspond to the operation 300 of FIG. 3.

In operation 410, the at least one processor 201 may identify third network information used by a first external electronic device 210 for accessing a second external electronic device 240. In FIG. 4, the third network information may represent the first network information used by the first external electronic device 210 for accessing the second external electronic device 240 in FIG. 3.

The at least one processor 201 may identify a third service set identifier and a third password in the third network information. The third service set identifier of FIG. 4 may be the same as the first service set identifier of FIG. 3. The third password of FIG. 4 may be the same as the first password of FIG. 3.

In operation 420, the at least one processor 201 may attempt to access the second external electronic device 240 using the third network information. For example, the at least one processor 201 may attempt to access the second external electronic device 240 using the third service set identifier and the third password in the third network information.

The at least one processor 201 may determine that the third service set identifier and/or the third password in the third network information is not changed, based on a success of accessing the second external electronic device 240 in accordance with the attempt performed using the third service set identifier and the third password. For example, in a case that the at least one processor 201 succeeds in accessing the second external electronic device 240 in accordance with the attempt, it may determine that the third service set identifier used by the first external electronic device 210 for accessing the second external electronic device 240 is not changed. For example, in a case that the at least one processor 201 succeeds in accessing the second external electronic device 240 in accordance with the attempt, it may determine that the third password used by the first external electronic device 210 for accessing the second external electronic device 240 is not changed. In operation 420, in a case that the at least one processor 201 identifies that the third service set identifier and/or the third password in the third network information is not changed, the at least one processor 201 may perform the operation 330 of FIG. 3.

The at least one processor 201 may determine that the service set identifier and/or the password in the third network information is changed based on a failure of accessing the second external electronic device 240 in accordance with the attempt performed using the password and the service set identifier in the third network information. For example, in a case that the at least one processor 201 fails to access the second external electronic device 240 in accordance with the attempt, it may determine that the third service set identifier used by the first external electronic device 210 for accessing the second external electronic device 240 is changed. For example, in a case that the at least one processor 201 fails to access the second external electronic device 240 in accordance with the attempt, it may determine that the third password used by the first external electronic device 210 for accessing the second external electronic device 240 is changed. For example, in a case that the at least one processor 201 fails to access the second external electronic device 240 in accordance with the attempt, it may determine that both the service set identifier and the password used by the first external electronic device 210 for accessing the second external electronic device 240 are changed.

In a case of determining that the third service set identifier and/or the third password in the third network information is changed, the at least one processor 201 may perform the following operation 430.

In operation 430, the at least one processor 201 may attempt to access the second external electronic device 240 using fourth network information based on a failure of accessing attempted by using the third network information.

For example, in a case that the at least one processor 201 fails to access the second external electronic device 240 using the third network information, the at least one processor 201 may attempt to access the second external electronic device 240 using the fourth network information. The fourth network information may represent network information used by the electronic device 200 for accessing the second external electronic device 240. For example, the fourth network information used by the electronic device 200 for accessing the second external electronic device 240 may be stored in memory 207 of the electronic device 200 before the at least one processor 201 receives the first message. For example, the at least one processor 201 may display a screen for obtaining the fourth network information through a display 209 before receiving the first message. The at least one processor 201 may receive an input from a user in association with the screen displayed through the display 209. The at least one processor 201 may obtain the fourth network information based on the received input. For example, the at least one processor 201 may obtain a fourth service set identifier and a fourth password in the fourth network information based on the received input. The at least one processor 201 may store the fourth network information, used by the electronic device 200 for accessing the second external electronic device 240, obtained in accordance with the input in the memory 207.

In operation 430, in a case that the at least one processor 201 succeeds in accessing the second external electronic device 240 using the fourth network information, the at least one processor 201 may transmit the fourth network information to the first external electronic device 210. In a case of succeeding in accessing the second external electronic device 240 using the fourth service set identifier and the fourth password in the fourth network information, the at least one processor 201 may determine that the fourth network information is available in the first external electronic device 210. The at least one processor 201 may transmit the fourth network information to the first external electronic device 210 based on determining that the fourth network information is available in the first external electronic device 210.

As described above in FIG. 4, by receiving the first message, the at least one processor 201 of the electronic device 200 may attempt to access the second external electronic device 240 by preferentially using the third network information received from the server 230. The at least one processor 201 may identify whether the third service set identifier and the third password in the third network information for accessing the second external electronic device 240 are changed, by attempting to access the second external electronic device 240 by preferentially using the third service set identifier and the third password in the third network information, which were used by the first external electronic device 210 for accessing the second external electronic device 240. In a case that the at least one processor 201 identifies that the service set identifier and the password for accessing the second external electronic device 240 are not changed, the at least one processor 201 may not attempt to access the second external electronic device 240 using the fourth network information. The at least one processor 201 may simplify an operation of accessing the second external electronic device 240 by preferentially using the third network information.

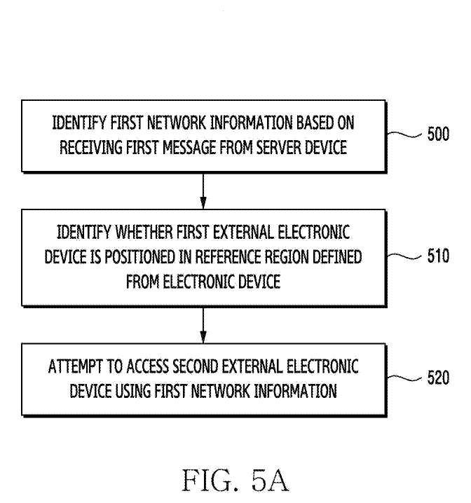

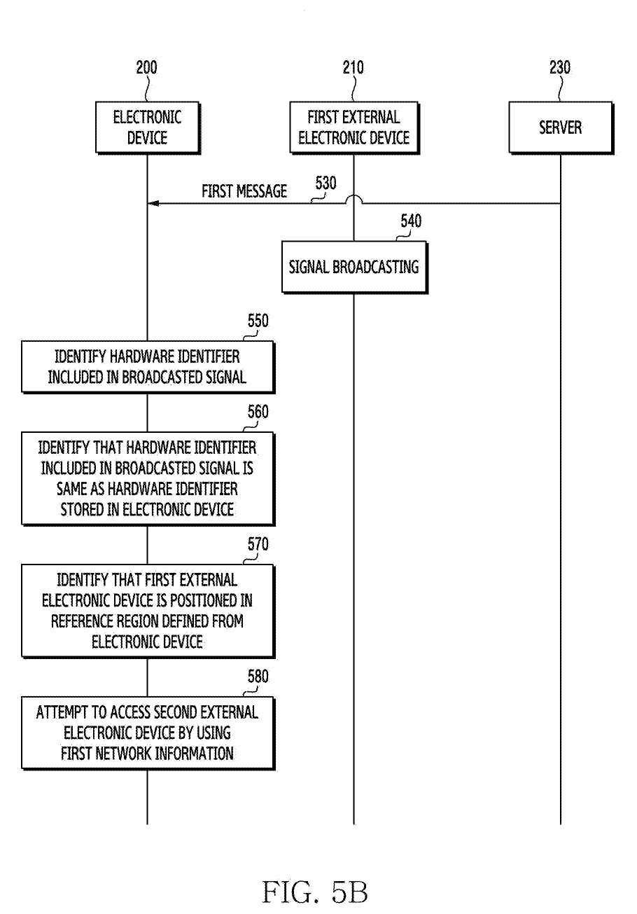

FIG. 5A is a flowchart illustrating an operation of an electronic device for attempting to access a second external electronic device in accordance with a first external electronic device positioned in a reference region defined from the electronic device according to an embodiment of the disclosure.

At least a portion of the methods of FIG. 5A may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 5A, in operation 500, the at least one processor 201 may identify first network information based on receiving a first message from a server device 230. For example, the at least one processor 201 may identify a first service set identifier and a first password in the first network information based on receiving the first message from the server 230.

In operation 510, the at least one processor 201 may identify whether a first external electronic device 210 is positioned in a reference region defined from the electronic device 200. For example, the at least one processor 201 may identify whether the first external electronic device 210 is positioned in the reference region defined from the electronic device 200, in accordance with whether a broadcasted signal may be received from the first external electronic device 210. A specific content regarding an operation of identifying whether the first external electronic device 210 is positioned in the reference region defined from the electronic device 200 will be described below with reference to FIG. 5B.

In operation 520, the at least one processor 201 may attempt to access a second external electronic device 240 using the first network information, based on identifying that the first external electronic device 210 is positioned in the reference region. For example, the at least one processor 201 may attempt to access the second external electronic device 240 using the first service set identifier and the first password in the first network information in accordance with the first external electronic device 210 positioned in the reference region defined from the electronic device 200. The operation 520 of FIG. 5A may correspond to the operation 420 of FIG. 4.

FIG. 5B illustrates an operation of an electronic device for identifying that a first external electronic device is positioned in a reference region defined from the electronic device according to an embodiment of the disclosure.

At least a portion of the methods of FIG. 5B may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 5B, in operation 530, the electronic device 200 may receive a first message from a server 230. For example, the electronic device 200 may receive the first message including first network information from the server 230. A description regarding the operation 530 of FIG. 5B may correspond to the operation 300 of FIG. 3.

In operation 540, a first external electronic device 210 may broadcast a signal. For example, at least one processor 211 of the first external electronic device 210 may broadcast the signal for a Bluetooth low-energy (BLE) connection (or communication) through second communication circuitry 215 of the first external electronic device 210. The at least one processor 201 of the electronic device 200 may receive the broadcasted signal from the first external electronic device 210 through second communication circuitry 205. The second communication circuitry 205 of the electronic device 200 and the second communication circuitry 215 of the first external electronic device 210 may be used for the BLE connection.

For example, the first external electronic device 210 may be positioned in a region where the electronic device 200 may not receive the broadcasted signal from the first external electronic device 210. In a case that the electronic device 200 may not receive the broadcasted signal from the first external electronic device 210, the at least one processor 201 may identify that the first external electronic device 210 is not positioned within the reference region defined from the electronic device 200.

For example, the first external electronic device 210 may be positioned in a region where the electronic device 200 may receive the broadcasted signal from the first external electronic device 210. In a case that the electronic device 200 may receive the broadcasted signal from the first external electronic device 210, the at least one processor 201 may perform operation 550 to identify that the first external electronic device 210 is positioned within the reference region defined from the electronic device 200.

In operation 550, the at least one processor 201 of the electronic device 200 may identify a hardware identifier included in the broadcasted signal. For example, the at least one processor 201 of the electronic device 200 may receive the broadcasted signal through the second communication circuitry 205. For example, the at least one processor 201 may identify the hardware identifier for indicating the first external electronic device 210 included in the broadcasted signal, based on receiving the broadcasted signal. For example, the hardware identifier may include a media access control (MAC) address and/or a unique identifier (UID) of the first external electronic device 210.

In operation 560, the at least one processor 201 of the electronic device 200 may identify that the hardware identifier included in the broadcasted signal is the same as a hardware identifier stored in the electronic device 200. For example, the hardware identifier stored in the electronic device 200 may be identified from the first message. For example, the hardware identifier may be identified from the first network information included in the first message. The at least one processor 201 of the electronic device 200 may identify the hardware identifier from the first network information included in the first message. The at least one processor 201 may store the hardware identifier identified from the first network information in memory 237 of the electronic device 200.

The at least one processor 201 may identify that the hardware identifier identified from the first network information, stored in the electronic device 100, is the same as the hardware identifier included in the broadcasted signal from the first external electronic device 210 in operation 540. For example, the at least one processor 201 may identify whether a MAC address or UID included in the broadcasted signal is the same as a MAC address or UID identified from the first network information. In FIG. 5B, the at least one processor 201 identifies whether the MAC address and the UID identified from the broadcasted signal are the same as the MAC address and the UID identified from the first network information, but the disclosure is not limited thereto. For example, the at least one processor 201 may further identify whether a product number (e.g., a serial number) included in the broadcasted signal is the same as the product number identified from the first network information.

In operation 570, the at least one processor 201 of the electronic device 200 may identify that the first external electronic device 210 is positioned in the reference region defined from the electronic device 200. For example, the at least one processor 201 may identify that the MAC address or the UID included in the broadcasted signal is the same as the MAC address or the UID identified from the first network information. The at least one processor 201 may identify that the first external electronic device 210 is positioned in the reference region defined from the electronic device 200 based on identifying the sameness.

In operation 580, the at least one processor 201 of the electronic device 200 may attempt to access a second external electronic device 240 by using the first network information. A description regarding the operation 580 of FIG. 5B may correspond to the operation 520 of FIG. 5A.

As described above in FIGS. 5A and 5B, the at least one processor 201 of the electronic device 200 may attempt to access the second external electronic device 240 using the first network information, based on the first external electronic device 210 being positioned in the reference region defined from the electronic device 200. The at least one processor 201 may identify whether the first external electronic device 210 is positioned in the reference region defined from the electronic device 200 in order to transmit new second network information to the first external electronic device 210 that may not access the second external electronic device 240. The at least one processor 201 of the electronic device 200 may preemptively identify that the first external electronic device 210 is positioned in the reference region before attempting to access the second external electronic device 240 using the first network information. The at least one processor 201 may preemptively identify that the first external electronic device 210 is positioned in the reference region, and then transmit the second network information to be used for accessing the second external electronic device 240 to the first external electronic device 210 immediately.

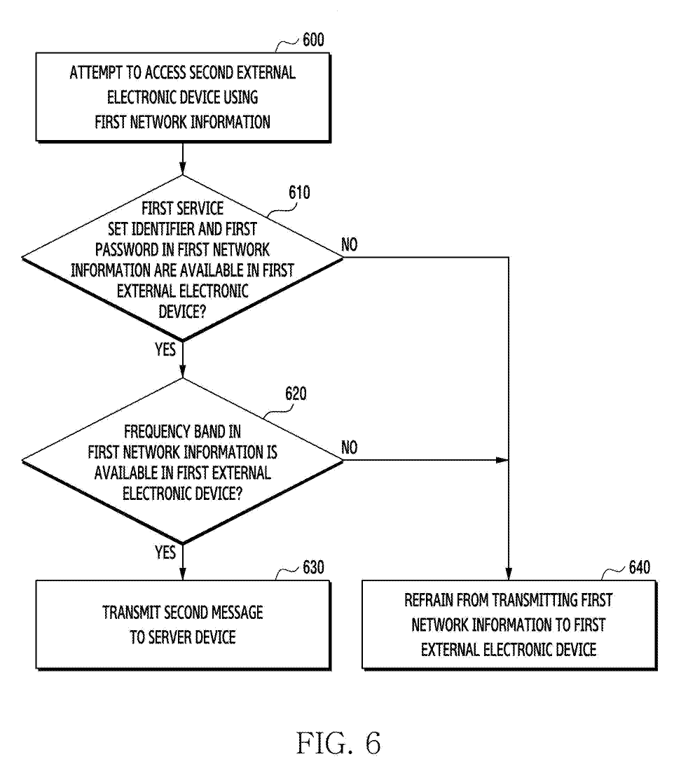

FIG. 6 is a flowchart illustrating an operation of an electronic device for identifying whether a service set identifier (SSID), a password, and a frequency band in first network information are available according to an embodiment of the disclosure.

At least a portion of the methods of FIG. 6 may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 6, in operation 600, the at least one processor 201 may attempt to access a second external electronic device 240 using first network information. A description regarding the operation 600 may correspond to the operation 310 of FIG. 3.

In operation 610, the at least one processor 201 may determine whether a first service set identifier and a first password in the first network information are available in a first external electronic device 210. For example, the at least one processor 201 may attempt to access the second external electronic device 240 using the first service set identifier and the first password in the first network information. In a case that the at least one processor 201 succeeds in accessing the second external electronic device 240 using the first service set identifier and the first password in the first network information, the at least one processor 201 may determine that the first service set identifier and the first password in the first network information are available in the first external electronic device 210. In operation 610, the at least one processor 201 may perform operation 620 in a case of determining that the first service set identifier and the first password in the first network information are available in the first external electronic device 210.

In contrast, in a case that at least one processor 201 fails to access the second external electronic device 240 using the first service set identifier and the first password in the first network information, the at least one processor 201 may determine that the first service set identifier or the first password in the first network information is not available in the first external electronic device 210. In operation 610, the at least one processor 201 may perform operation 640 in a case of determining that the first service set identifier and the first password in the first network information are not available in the first external electronic device 210.

In operation 620, the at least one processor 201 may determine whether a frequency band in the first network information is available in the first external electronic device 210. The at least one processor 201 may identify a frequency band used for the access from the first network information, in accordance with succeeding in accessing the second external electronic device 240 by using the first service set identifier and the first password in the first network information. The frequency band used by the electronic device 200 for accessing the second external electronic device 240 identified from the first network information may include a frequency band of a wireless network (or a Wi-Fi network) provided by the second external electronic device 240.

The at least one processor 201 may identify, from the first network information, a candidate frequency band available in the first external electronic device 210. The candidate frequency band of the first external electronic device 210 may be transmitted to a server 230 when the first external electronic device 210 is registered in the server 230. The server 230 may store the candidate frequency band of the first external electronic device 210 transmitted from the first external electronic device 210 in memory 237 of the server 230. When a first message is transmitted to the electronic device 200, the first network information including the candidate frequency band may be transmitted to the electronic device 200 by being included in the first message. As a non-limiting example, the candidate frequency band may include a frequency band of about 2.4 GHz or about 5 GHz. The first external electronic device 210 may access the wireless network provided by the second external electronic device 240 using the frequency band of about 2.4 GHz or about 5 GHz.

The at least one processor 201 may determine whether the frequency band identified from the first network information is included in the candidate frequency band. For example, in a case that the candidate frequency band identified from the first network information is about 2.4 GHz or about 5 GHz, and the frequency band used by the first external electronic device 210 for accessing the second external electronic device 240 is about 2.4 GHz, the at least one processor 201 may determine that the frequency band used by the first external electronic device 210 for accessing the second external electronic device 240 is included in the candidate frequency band. The at least one processor 201 may determine that the frequency band identified from the first network information is available in the first external electronic device 210 based on determining that the frequency band is included in the candidate frequency band.

In contrast, in a case that the frequency band identified from the first network information is about 3 GHz, the at least one processor 201 may determine that the frequency band identified from the first network information is not included in the candidate frequency band. The at least one processor 201 may determine that the frequency band identified from the first network information is not available in the first external electronic device 210, based on determining that the frequency band identified from the first network information is not included in the candidate frequency band. As a non-limiting example, in a case that the candidate frequency band available in the first external electronic device 210 is about 5 GHz and the frequency band identified from the first network information is about 2.4 GHz, the at least one processor 201 may determine that the frequency band identified from the first network information is not available in the first external electronic device 210.

In operation 620, in a case that the at least one processor 201 determines that the frequency band in the first network information is available in the first external electronic device 210, the at least one processor 201 may perform operation 630. For example, in a case that the at least one processor 201 determines that the frequency band included in the first network information is available in the second external electronic device 240, the at least one processor 201 may perform the operation 630. Alternatively, in operation 620, in a case that the at least one processor 201 determines that the frequency band in the first network information is not available in the first external electronic device 210, the at least one processor 201 may perform the operation 640.

In operation 630, the at least one processor 201 may transmit a second message to the server device 230 through first communication circuitry 203. For example, the at least one processor 201 may transmit the second message to the server device 230 representing that the first network information is available for the first external electronic device 210 to access the second external electronic device 240. As an example, in a case that the at least one processor 201 determines that the first service set identifier, the first password, and the frequency band in the first network information are available in the first external electronic device 210, the at least one processor 201 may transmit the second message to the server device 230.

The at least one processor 201 of the electronic device 200 may determine that an offline status of the first external electronic device 210 and one or more other external electronic devices has not occurred by a change in the first network information, based on determining that the first network information is available in the first external electronic device 210. For example, in a case that the first network information is available in the first external electronic device 210, the offline status may be due to power of the first external electronic device 210 and the other external electronic devices being off.

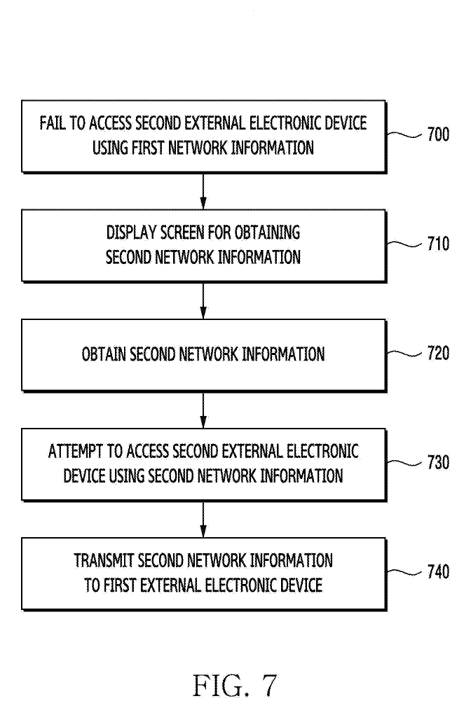

In operation 640, the at least one processor 201 may refrain from transmitting the first network information to the first external electronic device 210. For example, in operation 610, in a case that the at least one processor 201 determines that the first service set identifier or the first password in the first network information is not available in the first external electronic device 210, the at least one processor 201 may refrain from transmitting the first network information to the first external electronic device 210. The at least one processor 201 may obtain second network information for accessing the second external electronic device 240 based on refraining from transmitting the first network information to the first external electronic device 210. A specific content regarding an operation of the at least one processor 201 obtaining the second network information will be described below with reference to FIG. 7.

In operation 620, in a case that the at least one processor 201 determines that the frequency band in the first network information is not available in the first external electronic device 210, the at least one processor 201 may refrain from transmitting the first network information to the first external electronic device 210. The at least one processor 201 may display a screen representing that the frequency band in the first network information is not available in the first external electronic device 210 through a display 209, based on refraining from transmitting the first network information to the first external electronic device 210.

Referring to the above description in FIG. 6, as the at least one processor 201 further determines whether the frequency band included in the first network information is available in the first external electronic device 210, reliability of the first network information may be guaranteed. For example, the at least one processor 201 may further determine whether the frequency band included in the first network information is available in the first external electronic device 210, thereby further identifying whether the offline status of the first external electronic device 210 and the other external electronic devices is association with the frequency band of the wireless network provided by the second external electronic device 240.

In FIG. 6, it is described that the at least one processor 201 of the electronic device 200 performs the operation 600 to the operation 620 only on the first network information, but embodiments of the disclosure are not limited thereto. In addition to the first network information, the at least one processor 201 of the electronic device 200 may perform the same operations as the operation 600 to the operation 620 with respect to the second network information and fourth network information.

The at least one processor 201 may attempt to access the second external electronic device 240 by using the fourth network information of FIG. 4. The at least one processor 201 may determine whether the fourth network information is available in the first external electronic device 210. For example, the at least one processor 201 may determine whether a fourth service set identifier, a fourth password, and a frequency band in the fourth network information are available in the first external electronic device 210. In a case that the at least one processor 201 determines that the fourth network information is available in the first external electronic device 210, the at least one processor 201 may transmit the fourth network information to the first external electronic device 210.

The at least one processor 201 may attempt to access the second external electronic device 240 by using the second network information of FIG. 3. The at least one processor 201 may determine whether the second network information is available in the first external electronic device 210. For example, the at least one processor 201 may determine whether a second service set identifier, a second password, and a frequency band in the second network information are available in the first external electronic device 210. In a case that the at least one processor 201 determines that the second network information is available in the first external electronic device 210, the at least one processor 201 may transmit the second network information to the first external electronic device 210.

FIG. 7 is a flowchart illustrating an operation of an electronic device for transmitting obtained second network information to a first external electronic device after obtaining the second network information according to an embodiment of the disclosure.

At least a portion of the methods of FIG. 7 may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 7, in operation 700, the at least one processor 201 may fail to access a second external electronic device 240 using first network information. The operation 700 may correspond to an operation in which the at least one processor 201 fails to access the second external electronic device 240 using a service set identifier and a password in the first network information in operation 610 of FIG. 6.

In operation 710, the at least one processor 201 may display a screen for obtaining the second network information. For example, the at least one processor 201 may display the screen for obtaining the second network information different from the first network information through a display 209. The at least one processor 201 may identify an input received in association with the screen displayed through the display 209. For example, the at least one processor 201 may receive the input in association with the second network information from a user by displaying the screen through display 209. A specific example of the screen displayed on the display 209 to obtain the second network information will be described below with reference to FIG. 10.

In operation 720, the at least one processor 201 may obtain the second network information. For example, the at least one processor 201 may identify the input received from the user. For example, the at least one processor 201 may obtain the second network information by identifying the received input. For example, the input identified by the at least one processor 201 may include a second service set identifier and a second password in the second network information.

The second network information may be different from the first network information. For example, the second service set identifier in the second network information may be different from the first service set identifier in the first network information. The second password in the second network information may be the same as the first password in the first network information. A corresponding case may be referred to as a case where a service set identifier for accessing the second external electronic device 240 is changed. For example, the second password in the second network information may be different from the first password in the first network information. The second service set identifier in the second network information may be the same as the first service set identifier in the first network information. A corresponding case may be referred to as a case where a password for accessing the second external electronic device 240 is changed. For example, the second service set identifier in the second network information may be different from the first service set identifier in the first network information. The second password in the second network information may be different from the first password in the first network information. A corresponding case may be referred to as a case where a service set identifier and a password for accessing another AP device are changed by changing the second external electronic device 240 to the other AP device.

In operation 730, the at least one processor 201 may attempt to access the second external electronic device 240 using the second network information. For example, the at least one processor 201 may attempt to access the second external electronic device 240 using the second service set identifier and the second password in the second network information. In a case that the at least one processor 201 succeeds in accessing the second external electronic device 240 using the second service set identifier and the second password in the second network information, the at least one processor 201 may determine that the second service set identifier and the second password in the second network information are available in the first external electronic device 210.

The at least one processor 201 may identify a frequency band used for the access from the second network information as it succeeds in accessing the second external electronic device 240 by using the service set identifier and the password included in the second network information. The at least one processor 201 may determine whether the frequency band identified from the second network information is included in a candidate frequency band available in the first external electronic device 210. For example, in a case that the frequency band identified from the second network information is included in the candidate frequency band, the at least one processor 201 may determine that the frequency band identified from the second network information is available. For example, in a case that the frequency band identified from the second network information is about 2.4 GHz and the candidate frequency band available in the first external electronic device 210 is about 2.4 GHz or about 5 GHz, the at least one processor 201 may determine that the frequency band identified from the second network information is included in the candidate frequency band. The at least one processor 201 may perform the following operation 730 based on determining that the frequency band identified from the second network information is included in the candidate frequency band.

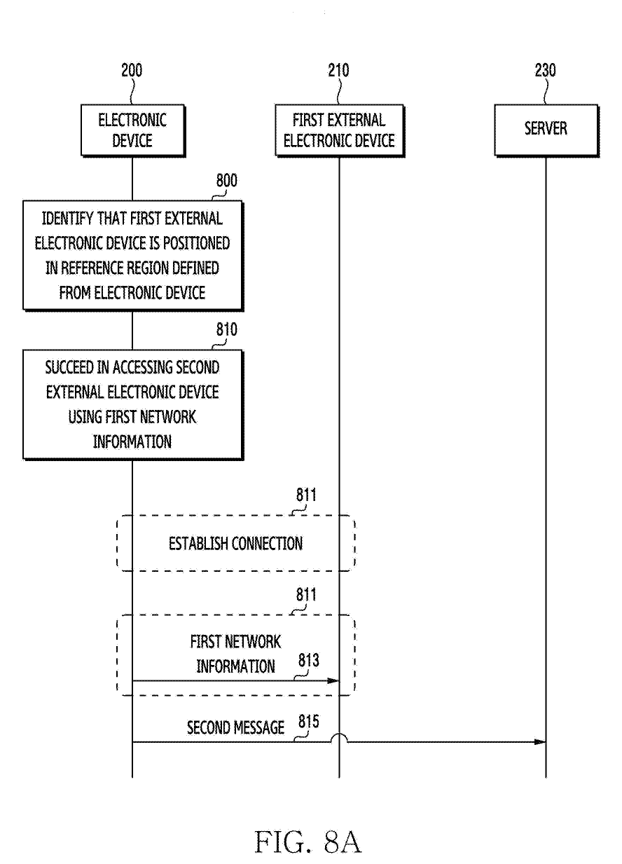

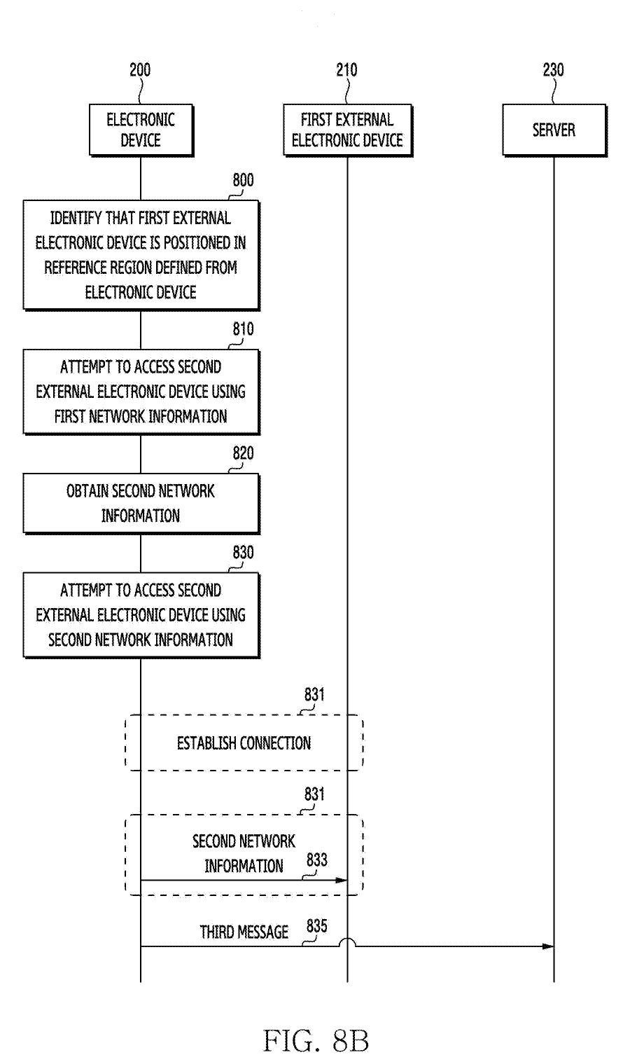

In operation 740, the at least one processor 201 may transmit the second network information to the first external electronic device 210. For example, the at least one processor 201 may transmit the second network information to the first external electronic device 210, based on determining that the second service set identifier, the second password, and the frequency band in the second network information are available in the first external electronic device 210. For example, the at least one processor 201 may transmit the second network information to the first external electronic device 210 after establishing a connection with the first external electronic device 210 through first communication circuitry 203 or second communication circuitry 205. After receiving the second network information transmitted from the electronic device 200, the first external electronic device 210 may attempt to access the second external electronic device 240 using the second network information. A specific content regarding the connection established between the electronic device 200 and the first external electronic device 210 to transmit the second network information will be described below with reference to FIGS. 8B and 9B.

In a case that the first external electronic device 210 is replaced with another AP device, the at least one processor 201 may determine whether the second network information is available in the other AP electronic device. For example, the at least one processor 201 may determine that the second service set identifier, the second password, and the frequency band in the second network information are available in the other AP device. Based on the determination, the at least one processor 201 may transmit the second network information used for accessing the other AP device to the first external electronic device 210. After receiving the second network information transmitted from the electronic device 200, the first external electronic device 210 may attempt to access the second external electronic device 240 using the second network information.

Referring to the above description in FIG. 7, the at least one processor 201 may obtain the second network information based on determining that the first service set identifier or the first password in the first network information is not available in the first external electronic device 210. The at least one processor 201 may update network information available for the first external electronic device 210 to access the second external electronic device 240, by performing the operation 700 to the operation 740. The at least one processor 201 may assist the first external electronic device 210 in accessing the second external electronic device 240 by transmitting the second network information available in the first external electronic device 210.

FIG. 8A illustrates an operation of an electronic device for transmitting first network information to a first external electronic device according to an embodiment of the disclosure.

At least a portion of the methods of FIG. 8A may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 8A, in operation 800, the at least one processor 201 of the electronic device 200 may identify that a first external electronic device 210 is positioned in a reference region defined from the electronic device 200. For example, the operation 800 of FIG. 8A may correspond to the operation 570 of FIG. 5B.

In operation 810, the at least one processor 201 of the electronic device 200 may attempt to access a second external electronic device 240 by using first network information. For example, the operation 810 of FIG. 8A may correspond to the operation 580 of FIG. 5B.

The at least one processor 201 of the electronic device 200 may establish a connection 811 with the second external electronic device 240. For example, in a case that the at least one processor 201 determines that a first service set identifier, a first password, and a frequency band in the first network information are available, the at least one processor 201 may establish the connection 811 for transmitting the first network information to the first external electronic device 210. The at least one processor 201 may establish the connection 811 with the first external electronic device 210 through second communication circuitry 205. The second communication circuitry 205 may be used for a BLE connection (or communication).

In operation 813, the at least one processor 201 of the electronic device 200 may transmit the first network information to the first external electronic device 210 using the connection 811. For example, the at least one processor 201 may transmit the first network information available in the first external electronic device 210, to the first external electronic device 210 through the second communication circuitry 205 by using the connection 811.

The first network information used by the first external electronic device 210 for accessing the second external electronic device 240 may be deleted from memory 217 of the first external electronic device 210. In a case that the first network information is deleted from the memory 217, the first external electronic device 210 may not access the second external electronic device 240 even though the first network information for accessing the second external electronic device 240 has not been changed. In order to prevent an inaccessible status of the first external electronic device 210 to the second external electronic device 240, the electronic device 200 may transmit the first network information to the first external electronic device 210.

At least one processor 211 of the first external electronic device 210 may receive the first network information using the connection 811. For example, the at least one processor 211 of the first external electronic device 210 may receive the first network information through the second communication circuitry 215 of the first external electronic device 210. The at least one processor 211 of the first external electronic device 210 may attempt to access the second external electronic device 240 by using the first service set identifier and the first password in the first network information received.

In a case that the first external electronic device 210 succeeds in accessing the second external electronic device 240 using the first network information, the at least one processor 211 of the first external electronic device 210 may periodically transmit a signal related to an operation of the first external electronic device 210 to a server 230 through first communication circuitry 213. At least one processor 231 of the server 230 may periodically receive the signal transmitted from the first external electronic device 210 through first communication circuitry 233. The at least one processor 231 of the server 230 may transmit, to the electronic device 200, information representing that the signal is periodically received at the server 230 from the first external electronic device 210 through the first communication circuitry 233. The at least one processor 201 of the electronic device 200 may receive the information representing that the signal is periodically received at the server 230 through the first communication circuitry 203. The at least one processor 201 of the electronic device 200 may identify that the first external electronic device 210 is connected to the server 230 by receiving the information representing that the signal is periodically received at the server 230.

The electronic device 200 may control the first external electronic device 210 in a case that the first external electronic device 210 is connected to the server 230 again by accessing the second external electronic device 240. For example, the electronic device 200 may transmit a control command for controlling the first external electronic device 210 to the server 230. The server 230 may transmit a request signal including the control command to the first external electronic device 210. The first external electronic device 210 may periodically transmit a response signal corresponding to the request signal to the server 230 based on receiving the request signal. The response signal may represent that the first external electronic device 210 performs an operation included in the control command.

In operation 815, the at least one processor 201 of the electronic device 200 may transmit a second message to the server 230 through the first communication circuitry 203. The second message may represent that the first network information is available for the first external electronic device 210 to access the second external electronic device 240. For example, in operation 815, the at least one processor 201 of the electronic device 200 may transmit the second message to the server 230 through the first communication circuitry 203. The second message may represent that the first network information is available for the first external electronic device 210 to access the second external electronic device 240. For example, the second message may indicate that an offline status of the first external electronic device 210 and one or more other external electronic devices that accessed the second external electronic device 240, has not occurred due to a change in the first network information. Based on receiving the second message, the server 230 may determine that the offline status of the first external electronic device 210 and one or more other external electronic devices that accessed the second external electronic device 240 is not due to the change in the first network information.

FIG. 8B illustrates an operation of an electronic device for transmitting second network information to a first external electronic device according to an embodiment of the disclosure.

At least a portion of the methods of FIG. 8B may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 8B, in operation 800, the at least one processor 201 of the electronic device 200 may identify that a first external electronic device 210 is positioned in the reference region defined from the electronic device 200. For example, the operation 800 of FIG. 8B may correspond to the operation 570 of FIG. 5B.

In operation 810, the at least one processor 201 of the electronic device 200 may attempt to access a second external electronic device 240 by using first network information. For example, the operation 810 of FIG. 8B may correspond to the operation 580 of FIG. 5B.

In operation 820, the at least one processor 201 of the electronic device 200 may obtain second network information. For example, in a case that the at least one processor 201 determines that a first service set identifier or a first password in the first network information is not available, the at least one processor 201 may obtain the second network information. For example, the operation 820 of FIG. 8B may correspond to the operation 710 and operation 720 of FIG. 7. For example, in operation 820, the at least one processor 201 may display a screen for obtaining the second network information. The at least one processor 201 may obtain the second network information by identifying an input received in association with the screen.

In operation 830, the at least one processor 201 of the electronic device 200 may attempt to access the second external electronic device 240 using the second network information. For example, the operation 820 of FIG. 8B may correspond to the operation 730 of FIG. 7.

The at least one processor 201 of the electronic device 200 may establish a connection 831 with the second external electronic device 240. For example, in a case that the at least one processor 201 determines that a second service set identifier, a second password, and a frequency band in the second network information are available, the at least one processor 201 may establish the connection 831 for transmitting the second network information to the first external electronic device 210. For example, the at least one processor 201 may establish the connection 831 with the first external electronic device 210 through second communication circuitry 205. For example, the second communication circuitry 205 may be used for a BLE connection (or communication).

In operation 833, the at least one processor 201 of the electronic device 200 may transmit the second network information to the first external electronic device 210 using the connection 831. As the electronic device 200 transmits the second network information to the first external electronic device 210, network information for accessing from the first external electronic device 210 to the second external electronic device 240 may be updated from the first network information to the second network information. At least one processor 211 of the first external electronic device 210 may receive the second network information using the connection 831. For example, the at least one processor 211 of the first external electronic device 210 may receive the second network information through second communication circuitry 215 of the first external electronic device 210. The at least one processor 211 of the first external electronic device 210 may attempt to access the second external electronic device 240 by using the second service set identifier and the second password of the second network information received. The first external electronic device 210 may be connected to a server 230 again by accessing the second external electronic device 240. As a non-limiting example, the at least one processor 211 of the first external electronic device 210 may attempt to access another AP device by using the second service set identifier and the second password of the second network information received. In a case that the second external electronic device 240 is changed (or replaced) to the other AP device, the first external electronic device 210 may be connected to the server 230 again by accessing the other AP device.

In a case that the first external electronic device 210 succeeds in accessing the second external electronic device 240 or the other AP device using the second network information, the at least one processor 211 of the first external electronic device 210 may periodically transmit a signal in association with an operation of the first external electronic device 210 to the server 230 through first communication circuitry 213. At least one processor 231 of the server 230 may periodically receive the signal transmitted from the first external electronic device 210 through first communication circuitry 233. The at least one processor 231 of the server 230 may transmit, to the electronic device 200, information representing that the signal is periodically received at the server 230 from the first external electronic device 210 through the first communication circuitry 233. The at least one processor 201 of the electronic device 200 may receive the information representing that the signal is periodically received at the server 230 through first communication circuitry 203. The at least one processor 201 of the electronic device 200 may identify that the first external electronic device 210 is connected to the server 230 by receiving the information representing that the signal is periodically received at the server 230.

The electronic device 200 may control the first external electronic device 210 in a case that the first external electronic device 210 is connected to the server 230 again by accessing the second external electronic device 240 or the other AP device. For example, the electronic device 200 may transmit a control command for controlling the first external electronic device 210 to the server 230. The server 230 may transmit a request signal including the control command to the first external electronic device 210. The first external electronic device 210 may periodically transmit a response signal corresponding to the request signal to the server 230 based on receiving the request signal. The response signal may represent that the first external electronic device 210 performs an operation included in the control command.

In operation 835, the at least one processor 201 of the electronic device 200 may transmit a third message to the server 230 through the first communication circuitry 203. The third message may represent that the electronic device 200 and the first external electronic device 210 are positioned in a place in which the second external electronic device 240 or the other AP device is positioned. The third message may represent that the second network information is used for the first external electronic device 210 to accessing the second external electronic device 240 or the other AP device. For example, the third message may represent that network information for accessing the second external electronic device 240 or the other AP device is updated from the first network information to the second network information. The server 230 may identify that the network information for a connection of the first external electronic device 210 to the server 230 was updated to the second network information based on receiving the third message.

Referring to the above description in FIGS. 8A and 8B, the at least one processor 201 may transmit the first network information or the second network information available in the first external electronic device 210 for accessing the second external electronic device 240 using the connection 811 or the connection 831 established using the BLE to the first external electronic device 210 through the second communication circuitry 205.

In a case that the electronic device 200 may establish a connection with the first external electronic device 210 only through the second communication circuitry 205, the at least one processor 201 of the electronic device 200 may establish a connection with the first external electronic device 210 through the second communication circuitry 205. For example, in a case that it is impossible for the first external electronic device 210 to access a Wi-Fi network activated by the electronic device 200, the at least one processor 201 may transmit the first network information or the second network information to the first external electronic device 210 through the second communication circuitry 205 using the connection 811 or the connection 831 established using the BLE.

FIG. 9A illustrates another operation of an electronic device for transmitting first network information to a first external electronic device according to an embodiment of the disclosure.

At least a portion of the methods of FIG. 9A may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 9A, in operation 900, the electronic device 200 may receive a first message from a server 230. For example, the operation 900 of FIG. 9A may correspond to the operation 300 of FIG. 3.

In operation 910, the at least one processor 201 of the electronic device 200 may attempt to access a second external electronic device 240 by using first network information. For example, the operation 910 of FIG. 9A may correspond to the operation 580 of FIG. 5B.

In operation 920, the at least one processor 201 of the electronic device 200 may broadcast a service set identifier of the electronic device 200 to establish a connection 931 with a first external electronic device 210. For example, in a case that the at least one processor 201 determines that a first service set identifier, a first password, and a frequency band in the first network information are available, the at least one processor 201 may perform the operation 920. For example, the at least one processor 201 may perform the operation 920 to establish the connection 931 for transmitting the first network information available in the first external electronic device 210 to the first external electronic device 210.

The at least one processor 201 may broadcast the service set identifier of the electronic device 200 through first communication circuitry 203 by activating a local hotspot mode of the electronic device 200. The at least one processor 201 may provide a wireless network of the electronic device 200 through the first communication circuitry 203 by executing the local hotspot mode. For example, the wireless network provided from the electronic device 200 through the first communication circuitry 203 may be a Wi-Fi network.

At least one processor 211 of the first external electronic device 210 may access the electronic device 200 in which the local hotspot mode is activated based on a service set identifier and a password for accessing the electronic device 200. For example, the at least one processor 211 of the first external electronic device 210 may access the wireless network provided by the electronic device 200 by accessing the electronic device 200.

In operation 930, the electronic device 200 may receive a response representing that the service set identifier for accessing the electronic device 200 is searched from the first external electronic device 210. For example, the at least one processor 201 may receive the response representing that the service set identifier for accessing the electronic device 200 is searched from the first external electronic device 210.

In a case that the local hotspot mode of the electronic device 200 is activated, at least one processor 211 of the first external electronic device 210 may search for the service set identifier broadcasted from the electronic device 200. In a case that the at least one processor 211 of the first external electronic device 210 searches for the service set identifier broadcasted from the electronic device 200, the at least one processor 211 may transmit a response representing that the broadcasted service set identifier is searched from the electronic device 200 through first communication circuitry 213 of the first external electronic device 210. The at least one processor 201 of the electronic device 200 may receive the response transmitted from the first external electronic device 210 through the first communication circuitry 203.

The at least one processor 211 of the first external electronic device 210 may access the wireless network provided by the electronic device 200 using the password for accessing the electronic device 200. For example, in a case that the service set identifier broadcasted from the electronic device 200 is searched, the at least one processor 211 of the first external electronic device 210 may access the wireless network provided by the electronic device 200 through the first communication circuitry 213 of the first external electronic device 210, using the password for accessing the electronic device 200. The password for accessing the electronic device 200 may be stored in memory 217 of the first external electronic device 210.

The at least one processor 201 of the electronic device 200 may establish the connection 931 with the first external electronic device 210 by using the first communication circuitry 203. For example, in a case that the at least one processor 201 determines that the first service set identifier, the first password, and the frequency band in the first network information are available, the at least one processor 201 may establish the connection 931 for transmitting the first network information to the first external electronic device 210. For example, the at least one processor 201 may establish the connection 931 with the first external electronic device 210 through the first communication circuitry 203. The first communication circuitry 203 may be used for a Wi-Fi network (or communication).

In operation 933, the at least one processor 201 of the electronic device 200 may transmit the first network information to the first external electronic device 210 using the connection 931. The at least one processor 211 of the first external electronic device 210 may receive the first network information using the connection 931. For example, the at least one processor 211 of the first external electronic device 210 may receive the first network information using the first communication circuitry 213 of the first external electronic device 210. The at least one processor 211 of the first external electronic device 210 may attempt to access the second external electronic device 240 by using the first service set identifier and the first password in the first network information received.

In a case that the first external electronic device 210 succeeds in accessing the second external electronic device 240 using the first network information, the at least one processor 211 of the first external electronic device 210 may periodically transmit a signal related to an operation of the first external electronic device 210 to the server 230 through the first communication circuitry 213. At least one processor 231 of the server 230 may periodically receive the signal transmitted from the first external electronic device 210 through first communication circuitry 233. The at least one processor 231 of the server 230 may transmit, to the electronic device 200 through the first communication circuitry 233, information representing that the signal is periodically received at the server 230 from the first external electronic device 210. The at least one processor 201 of the electronic device 200 may receive the information representing that the signal is periodically received at the server 230 through the first communication circuitry 203. The at least one processor 201 of the electronic device 200 may identify that the first external electronic device 210 is connected to the server 230 by receiving the information representing that the signal is periodically received at the server 230.

In a case that the first external electronic device 210 is connected to the server 230 again by accessing the second external electronic device 240, the electronic device 200 may control the first external electronic device 210. For example, the electronic device 200 may transmit a control command for controlling the first external electronic device 210 to the server 230. The server 230 may transmit a request signal including the control command to the first external electronic device 210. The first external electronic device 210 may periodically transmit a response signal corresponding to the request signal to the server 230 based on receiving the request signal. The response signal may represent that the first external electronic device 210 performs an operation included in the control command.

In operation 937, the at least one processor 201 of the electronic device 200 may transmit a second message to the server 230 through the first communication circuitry 203. The operation 937 of FIG. 9A may correspond to the operation 815 of FIG. 8A.

FIG. 9B illustrates another operation of an electronic device for transmitting second network information to a first external electronic device according to an embodiment of the disclosure.

At least a portion of the methods of FIG. 9B may be performed by the electronic device 200 of FIG. 2. For example, the at least a portion of the methods may be controlled by at least one processor 201 of the electronic device 200. In the following embodiment, each operation may be sequentially performed, but is not necessarily performed sequentially. For example, an order of each operation may be changed, and at least two operations may be performed in parallel.

Referring to FIG. 9B, in operation 900, the electronic device 200 may receive a first message from a server 230. For example, the operation 900 of FIG. 9B may correspond to the operation 300 of FIG. 3.

In operation 910, the at least one processor 201 of the electronic device 200 may attempt to access a second external electronic device 240 by using first network information. For example, the operation 910 of FIG. 9B may correspond to the operation 580 of FIG. 5B.

In operation 911, the at least one processor 201 of the electronic device 200 may obtain second network information. For example, in a case that the at least one processor 201 determines that at least one of a first service set identifier, a first password, or a frequency band in the first network information is not available, the at least one processor 201 may obtain the second network information. The operation 911 of FIG. 9B may correspond to the operation 710 and operation 720 of FIG. 7. For example, in operation 911, the at least one processor 201 may display a screen for obtaining the second network information. The at least one processor 201 may obtain the second network information by identifying an input received in association with the screen.

In operation 913, the at least one processor 201 of the electronic device 200 may attempt to access the second external electronic device 240 using the second network information. For example, the operation 913 of FIG. 9B may correspond to the operation 730 of FIG. 7.

In operation 920, the at least one processor 201 of the electronic device 200 may broadcast a service set identifier of the electronic device 200 to establish a connection 931 with a first external electronic device 210. For example, in a case that the at least one processor 201 determines that a second service set identifier, a second password, and a frequency band in the second network information are available, the at least one processor 201 may perform the operation 920. The at least one processor 201 may perform the operation 920 to establish the connection 931 for transmitting the second network information available in the first external electronic device 210 to the first external electronic device 210. The operation 920 of FIG. 9B may correspond to the operation 920 of FIG. 9A.

In operation 930, the electronic device 200 may receive a response representing that the service set identifier for accessing the electronic device 200 is searched from the first external electronic device 210. For example, the operation 930 of FIG. 9B may correspond to the operation 930 of FIG. 9A.

The at least one processor 201 of the electronic device 200 may establish a connection with the first external electronic device 210 using first communication circuitry 203. For example, in a case that the at least one processor 201 determines that the second service set identifier, the second password, and the frequency band in the second network information are available, the at least one processor 201 may establish the connection 931 for transmitting the second network information to the first external electronic device 210. For example, the at least one processor 201 may establish the connection 931 with the first external electronic device 210 through the first communication circuitry 203. The first communication circuitry 203 may be used for a Wi-Fi network (or communication).

In operation 935, the at least one processor 201 of the electronic device 200 may transmit the second network information to the first external electronic device 210 using the connection 931. As the electronic device 200 transmits the second network information to the first external electronic device 210, network information for accessing from the first external electronic device 210 to the second external electronic device 240 may be updated from the first network information to the second network information. At least one processor 211 of the first external electronic device 210 may receive the second network information using the connection 931. For example, the at least one processor 211 of the first external electronic device 210 may receive the second network information through first communication circuitry 213 of the first external electronic device 210. The at least one processor 211 of the first external electronic device 210 may attempt to access the second external electronic device 240 by using the second service set identifier and the second password of the second network information received.

The first external electronic device 210 may be connected to the server 230 again by accessing the second external electronic device 240. As a non-limiting example, the at least one processor 211 of the first external electronic device 210 may attempt to access another AP device by using the second service set identifier and the second password of the second network information received. In a case that the second external electronic device 240 is changed (or replaced) to the other AP device, the first external electronic device 210 may be connected to the server 230 again by accessing the other AP device.

In a case that the first external electronic device 210 succeeds in accessing the second external electronic device 240 or the other AP device using the second network information, the at least one processor 211 of the first external electronic device 210 may periodically transmit a signal related to an operation of the first external electronic device 210 to the server 230 through the first communication circuitry 213. At least one processor 231 of the server 230 may periodically receive the signal transmitted from the first external electronic device 210 through first communication circuitry 233. The at least one processor 231 of the server 230 may transmit, to the electronic device 200, information representing that the signal is periodically received at the server 230 from the first external electronic device 210 through the first communication circuitry 233. The at least one processor 201 of the electronic device 200 may receive the information representing that the signal is periodically received at the server 230 through the first communication circuitry 203. The at least one processor 201 of the electronic device 200 may identify that the first external electronic device 210 is connected to the server 230 by receiving the information representing that the signal is periodically received at the server 230.

The electronic device 200 may control the first external electronic device 210 in a case that the first external electronic device 210 is connected to the server 230 again by accessing the second external electronic device 240 or the other AP device. For example, the electronic device 200 may transmit a control command for controlling the first external electronic device 210 to the server 230. The server 230 may transmit a request signal including the control command to the first external electronic device 210. The first external electronic device 210 may periodically transmit a response signal corresponding to the request signal to the server 230 based on receiving the request signal. The response signal may represent that the first external electronic device 210 performs an operation included in the control command.

In operation 939, the at least one processor 201 of the electronic device 200 may transmit a third message to the server 230 through the first communication circuitry 203. The operation 939 of FIG. 9B may correspond to the operation 835 of FIG. 8B.

Referring to the above description in FIGS. 9A and 9B, the at least one processor 201 may transmit the first network information or the second network information available in the first external electronic device 210 for accessing the second external electronic device 240 through the first communication circuitry 203, using the connection 931 established by using the local hotspot mode activated by the electronic device 200.

In a case that the electronic device 200 may establish a connection with the first external electronic device 210 only through the first communication circuitry 203, the at least one processor 201 of the electronic device 200 may establish a connection with the first external electronic device 210 through the first communication circuitry 203. For example, in a case that it is impossible for the first external electronic device 210 to support a BLE mode, the at least one processor 201 may transmit the first network information or the second network information to the first external electronic device 210 through the first communication circuitry 203, using the connection 931 established using the local hotspot mode activated by the electronic device 200.

FIG. 10 illustrates a screen displayed in an electronic device to obtain second network information when accessing a second external electronic device using first network information fails according to an embodiment of the disclosure.

Referring to FIG. 10, at least one processor 201 may display a screen 1001 through a display 209 when it fails to access a second external electronic device 240 using first network information stored in memory 207 of an electronic device 200. For example, the screen 1001 may include a text representing that the electronic device 200 fails to access the second external electronic device 240 using a first service set identifier and a first password in the first network information. As a non-limiting example, the text may include "update is required to connect to a Wi-Fi network".

The screen 1001 may further include a menu capable of receiving an input of a user. For example, the at least one processor 201 may identify an input 1001-1 of the user in association with the menu. For example, the at least one processor 201 may display a screen 1003 for obtaining the second network information based on identifying the input 1001-1 in which an "update" menu is selected. For example, the at least one processor 201 may refrain from displaying the screen 1003 for obtaining the second network information based on identifying an input in which a "cancel" menu is selected.

The screen 1003 may include a text 1003-2 for guiding a list of wireless networks to which the electronic device 200 is connectable. As a non-limiting example, the text 1003-2 may include a "connectable Wi-Fi list". The screen 1003 may include a visual object 1003-3 displaying a service set identifier of the wireless network to which the electronic device 200 is connectable. As a non-limiting example, the visual object 1003-3 may include a text "Wi-Fi #3". As a non-limiting example, the text included in the visual object 1003-3 may represent the second service set identifier of the second network information.

The at least one processor 201 may receive an input 1003-1 in association with the visual object 1003-3 displayed on the screen 1003 through the display 209. For example, the at least one processor 201 may identify the input 1003-1 of the user in association with the visual object 1003-3. For example, in a case that the user selects the visual object 1003-3, the at least one processor 201 may display a screen 1005 for obtaining a second password in the second network information by identifying the input 1003-1 for the visual object 1003-3.

In a case that at least one processor 201 identifies the input 1003-1 for the visual object 1003-3, the at least one processor 201 may display the screen 1005 for obtaining the second password in the second network information.

The screen 1005 may include a text 1005-1, a text 1005-2, and a visual object 1005-3. For example, the text 1005-1 may represent the second service set identifier of the second network information. For example, the text 1005-2 may include a text representing that the visual object 1005-3 displayed based on an input of the user is the second password in the second network information. As a non-limiting example, the text may include "password". The at least one processor 201 may identify the input received from the user in association with the screen 1005. As a non-limiting example, the input received from the user in association with the screen 1005 may include a combination of English, a combination of English and numbers, or a combination of numbers. The at least one processor 201 may obtain the password in the second network information based on identifying the input. The at least one processor 201 may display the screen 1005 including the visual object 1005-brepresenting the password through the display 209.

The at least one processor 201 may display a screen 1007 through the display 209 based on the electronic device 200 succeeding in accessing the second external electronic device 240 or another AP device using the second network information. For example, in a case that the at least one processor 201 of the electronic device 200 succeeds in accessing the second external electronic device 240 or the other AP device using the second service set identifier and the second password in the second network information, the at least one processor 201 may display the screen 1007 including a text 1007-1 through the display 209. The text 1007-1 may represent that the at least one processor 201 succeeds in accessing the second external electronic device 240 using the second service set identifier and the second password in the second network information. As a non-limiting example, the text 1007-1 may include "successfully connected to Wi-Fi #3”.

The at least one processor 201 may display the screen 1007 and then establish a connection (e.g., the connection 831 of FIG. 8B or the connection 931 of FIG. 9B) with the first external electronic device 210 through first communication circuitry 203 or second communication circuitry 205. The at least one processor 201 may transmit the second network information to the first external electronic device 210 using the connection.

As a non-limiting example, the at least one processor 201 may display the screen 1001 or the screen 1007 of FIG. 10 while executing a software application installed in the electronic device 200. As a non-limiting example, the software application may include a smart things application.

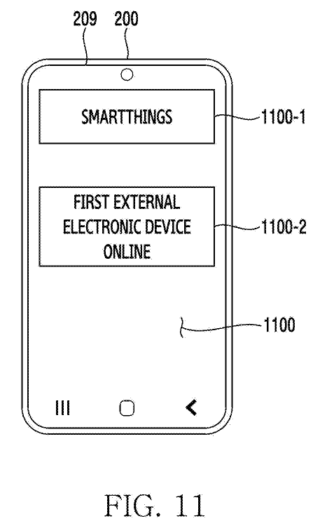

FIG. 11 illustrates a screen displayed in an electronic device to represent that a first external electronic device is connected to a server using second network information according to an embodiment of the disclosure.

Referring to FIG. 11, a first external electronic device 210 may receive the second network information from an electronic device 200 through first communication circuitry 213 or second communication circuitry 215. At least one processor 211 of the first external electronic device 210 may attempt to access a second external electronic device 240 or another AP device using the second network information. For example, the at least one processor 211 may attempt to access the second external electronic device 240 or the other AP device using a second service set identifier and a second password in the second network information. In a case that the first external electronic device 210 accesses the second external electronic device 240 or the other AP device, the at least one processor 211 of the first external electronic device 210 may access a wireless network provided from the second external electronic device 240 or the other AP device. The at least one processor 211 of the first external electronic device 210 may be connected to a server 230 using the wireless network provided from the second external electronic device 240 or the other AP device.

The first external electronic device 210 connected to the server 230 may periodically transmit a signal related to an operation of the first external electronic device 210 to the server 230. The server 230 may periodically receive the signal transmitted from the first external electronic device 210. At least one processor 231 of the server 230 may transmit, to the electronic device 200, information representing that the signal is periodically received at the server 230 from the first external electronic device 210 through first communication circuitry 233. At least one processor 201 of the electronic device 200 may receive the information representing that the signal is periodically received at the server 230 through the first communication circuitry 203.

At least one processor 201 may display a screen 1100 through a display 209 based on receiving the information representing that the signal is periodically received at the server 230. For example, the screen 1100 may include a visual object 1100-1 and a visual object 1100-2. For example, the visual object 1100-1 may represent a software application used by the at least one processor 201 to display the screen 1100. For example, the at least one processor 201 may display the screen 1100 through the display 209 based on receiving the information representing that the signal is periodically received at the server 230 while executing the software application installed in the electronic device 200. As a non-limiting example, the software application may include a smart things application.

The visual object 1100-2 may include a text representing that the first external electronic device 210 is connected to the server 230. For example, the visual object 1100-2 may include a text to represent that the signal is periodically received at the server 230 from the first external electronic device 210. As a non-limiting example, the text may include "first external electronic device Online".

FIG. 12 is a block diagram illustrating an electronic device 1201 in a network environment 1200 according to various embodiments.

Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In some embodiments, at least one of the components (e.g., the connecting terminal 1278) may be omitted from the electronic device 1201, or one or more other components may be added in the electronic device 1201. In some embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the millimeter wave (mmWave) band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20Gbps or more) for implementing eMBB, loss coverage (e.g., 1264dB or less) for implementing mMTC, or user plane (U-plane) latency (e.g., 0.5ms or less for each of downlink (DL) and uplink (UL), or a round trip of 12ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or the server 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The technical problems to be achieved in this document are not limited to those described above, and other technical problems not mentioned herein will be clearly understood by those who have ordinary knowledge in the art to which the disclosure belongs, from the following description.

As described above, a method performed by a server device (e.g., the server 230) may comprise identifying a connection status with the server device of an IoT device. The method may comprise, based on the connection status of the IoT device being an offline status, identifying a connection status of one or more other IoT devices, registered with respect to an access point (AP) device to which the IoT device connects for connecting to the server device. The method may comprise, based on the connection status of the one or more other IoT devices being the offline status, transmitting, to an electronic device, a first message for representing that a network connection problem occurred in association with the AP device. The first message may include first network information used for accessing the AP device such that the electronic device determines whether the first network information is available for accessing the AP device. The method may comprise receiving a second message including second network information available for accessing the AP device or another AP device, transmitted from the electronic device such that the first network information is updated to the second network information.

According to an embodiment, the second network information may be transmitted from the electronic device to the IoT device registered with respect to the AP device through a direct communication link between the electronic device and the IoT device registered with respect to the AP device.

According to an embodiment, identifying the connection status with the server device of the IoT device may comprise receiving, from the electronic device, a control command for controlling the IoT device registered in association with the electronic device. Identifying the connection status with the server device of the IoT device may comprise transmitting a request signal including the control command to the IoT device and activating a timer. Identifying the connection status with the server device of the IoT device may comprise, based on a response signal associated with the request signal being not received until expiration of the timer, identifying that the connection status of the IoT device is the offline status with the server device.

According to an embodiment, identifying that the connection status of the IoT device is the offline status with the server device may comprise, based on identifying that the connection status of the IoT device is the offline status with the server device, identifying the AP device, registered with respect to a place in which the IoT device is positioned, to which the IoT device was accessed for a connection with the server device.

According to an embodiment, the second message may represent that the IoT device registered with respect to the AP device and the electronic device are positioned in a place in which the AP device is positioned. A second password, included in the second network information in the second message, may be different from a first password, included in the first network information in the first message. The second password may allow the IoT device to access the AP device.

According to an embodiment, the second message may represent that the IoT device registered with respect to the AP device and the electronic device are positioned in a place in which the AP device is positioned. A second service set identifier (SSID), included in the second network information in the second message, may be different from a first SSID, included in the first network information in the first message. The second SSID may allow the IoT devices to access the AP device.

According to an embodiment, the second message may represent that the IoT device registered with respect to the AP device and the electronic device are positioned in a place in which the AP device is positioned. A second SSID and a second password, included in the second network information in the second message, may be different from a first SSID and a first password, included in the first network information in the first message. The second SSID and the second password may allow the IoT device to access the AP device.

As described above, a server device may comprise memory comprising one or more storage media storing instructions. The server device may comprise at least one processor including processing circuitry. The instructions, when executed by the at least one processor individually or collectively, may cause the server device to identify a connection status with the server device of an IoT device. The instructions, when executed by the at least one processor individually or collectively, may cause the server device to, based on the connection status of the IoT device being an offline status, identify a connection status of one or more other IoT devices, registered with respect to an access point (AP) device to which the IoT device was accessed for connecting to the server device. The instructions, when executed by the at least one processor individually or collectively, may cause the server device to, based on the connection status of the one or more other IoT devices being the offline status, transmit, to an electronic device, a first message representing that a network connection problem occurred in association with the AP device. The first message may include first network information used for accessing the AP device, such that the electronic device determines whether the first network information is available for accessing the AP device. The instructions, when executed by the at least one processor individually or collectively, may cause the server device to receive a second message, including second network information available for accessing the AP device or another AP device, transmitted from the electronic device, such that the first network information is updated to the second network information.

According to an embodiment, the second network information may be transmitted from the electronic device to the IoT device registered with respect to the AP device through a direct communication link between the electronic device and the IoT device registered with respect to the AP device.

According to an embodiment, the instructions, when executed by the at least one processor individually or collectively, may cause the server device to receive, from the electronic device, a control command for controlling the IoT device registered in association with the electronic device. The instructions, when executed by the at least one processor individually or collectively, may cause the server device to transmit a request signal including the control command to the IoT device and activate a timer. The instructions, when executed by the at least one processor individually or collectively, may cause the server device to, based on a response signal associated with the request signal being not received until expiration of the timer, identify that the connection status of the IoT device is the offline status with the server device.

According to an embodiment, the instructions, when executed by the at least one processor individually or collectively, may cause the server device to, based on identifying that the connection status of the IoT device is the offline status with the server device, identify the AP device, registered with respect to a place in which the IoT device is positioned, to which the IoT device was accessed for a connection with the server device.

According to an embodiment, the second message may represent that the IoT device registered with respect to the AP device and the electronic device are positioned in a place in which the AP device is positioned. A second password, included in the second network information in the second message, may be different from a first password, included in the first network information in the first message. The second password may allow the IoT device to access the AP device.

According to an embodiment, the second message may represent that the IoT device registered with respect to the AP device and the electronic device are positioned in a place in which the AP device is positioned. A second service set identifier (SSID), included in the second network information in the second message, may be different from a first SSID, included in the first network information in the first message. The second SSID may allow the IoT device to access the AP device.

According to an embodiment, the second message may represent that the IoT device registered with respect to the AP device and the electronic device are positioned in a place in which the AP device is positioned. A second SSID and a second password included in the second network information in the second message, may be different from a first SSID and a first password, included in the first network information in the first message. The second SSID and the second password may allow the IoT device to access the AP device.

As described above, a non-transitory computer readable storage medium may store one or more programs including instructions, when executed by a server device, that cause the server device to identify a connection status with the server device of an IoT device. The non-transitory computer readable storage medium may store the one or more programs including the instructions, when executed by the server device, that cause the server device to, based on the connection status of the IoT device being an offline status, identify a connection status of one or more other IoT devices, registered with respect to an access point (AP) device to which the IoT device connects for connecting to the server device. The non-transitory computer readable storage medium may store the one or more programs including the instructions, when executed by the server device, that cause the server device to, based on the connection status of the one or more other IoT devices being the offline status, transmit, to an electronic device, a first message representing that a network connection problem occurred in association with the AP device. The first message may include first network information used for accessing the AP device such that the electronic device determines whether the first network information is available for accessing the AP device. The non-transitory computer readable storage medium may store the one or more programs including the instructions, when executed by the server device, that cause the server device to receive a second message including second network information available for accessing the AP device or another AP device, transmitted from the electronic device such that the first network information is updated to the second network information.

As described above, an electronic device (e.g., the electronic device 200) may comprise first communication circuitry (e.g., the first communication circuitry 203) and second communication circuitry (e.g., the second communication circuitry 205). The electronic device may comprise memory (e.g., the memory 207) comprising one or more storage media storing instructions. The electronic device may comprise at least one processor (e.g., the at least one processor 201) comprising processing circuitry. The instructions, when executed by the at least one processor individually or collectively, may cause the electronic device to receive, from a server device, via the first communication circuitry, a first message representing that a network connection problem occurred in association with an access point (AP) device. One or more IoT devices may be registered in the server device in association with the electronic device. The instructions, when executed by the at least one processor individually or collectively, may cause the electronic device to, based on receiving the first message, attempt to access the access point (AP) device, using first network information included in the first message. The first network information may be used by the one or more IoT devices for accessing the AP device. The instructions, when executed by the at least one processor individually or collectively, may cause the electronic device to, based on a success of accessing the AP device in accordance with the attempt using the first network information, transmit, to the server device, via the first communication circuitry, a second message representing that the first network information is available for an access to the AP device. The instructions, when executed by the at least one processor individually or collectively, may cause the electronic device to, based on a failure of accessing the AP device in accordance with the attempt using the first network information, obtain second network information for accessing the AP device or another AP device. The instructions, when executed by the at least one processor individually or collectively, may cause the electronic device to, based on a success of accessing the AP device or the another AP device using the second network information, transmit, to the IoT device registered in the server device, via the first communication circuitry or the second communication circuitry, the second network information.

According to an embodiment, the instructions, when executed by the at least one processor individually or collectively, may cause the electronic device to, based on receiving the first network information from the server device, identify the first network information which was used by the one or more IoT devices for accessing the AP device. The instructions, when executed by the at least one processor individually or collectively, may cause the electronic device to attempt to access the AP device using a first service set identifier (SSID) and a first password in the first network information. The instructions, when executed by the at least one processor individually or collectively, may cause the electronic device to, based on a failure of accessing the AP device in accordance with the attempt performed using the first SSID and the first password, identify third network information which was used by the electronic device for accessing the AP device. The third network device may include a third SSID and a third password which was used by the electronic device for accessing the AP device. The instructions, when executed by the at least one processor individually or collectively, may cause the electronic device to attempt to access the AP using the third network information. The instructions, when executed by the at least one processor individually or collectively, may cause the electronic device to, based on a failure of accessing the AP device in accordance with the attempt using the third network information, obtain the second network information for accessing the AP device.

According to an embodiment, the instructions, when executed by the at least one processor individually or collectively, may cause the electronic device to, based on receiving the first message from the server, identify a first SSID and a first password in the first network information. The instructions, when executed by the at least one processor individually or collectively, may cause the electronic device to identify that the IoT device is positioned within a reference region defined from the electronic device. The instructions, when executed by the at least one processor individually or collectively, may cause the electronic device to, in accordance with the IoT device positioned in the reference region defined from the electronic device, perform the attempt using the first SSID and the first password in the first network information.

According to an embodiment, the second communication circuitry may be used for Bluetooth low energy (BLE) communication. The instructions, when executed by the at least one processor individually or collectively, may cause the electronic device to receive, via the second communication circuitry, signals broadcasted from the IoT device. The instructions, when executed by the at least one processor individually or collectively, may cause the electronic device to, based on receiving the broadcasted signals, identify a hardware identifier for indicating the IoT device registered in the server device. The instructions, when executed by the at least one processor individually or collectively, may cause the electronic device to, based on identifying that the identified hardware identifier is the same as a hardware identifier representing the IoT device registered in the server device stored in the electronic device, identify that the IoT device is positioned within the reference region defined from the electronic device.

According to an embodiment, the instructions, when executed by the at least one processor individually or collectively, may cause the electronic device to, based on the success of accessing the AP device or the another AP device using a second SSID and a second password in the second network information, identify, from the second network information, a frequency band used for accessing the AP device. The instructions, when executed by the at least one processor individually or collectively, may cause the electronic device to identify at least one candidate frequency band available in the IoT device from the first network information which was used by the IoT device for accessing the AP device. The instructions, when executed by the at least one processor individually or collectively, may cause the electronic device to determine whether the frequency band identified from the second network information is included in the at least one candidate frequency band. The instructions, when executed by the at least one processor individually or collectively, may cause the electronic device to, based on determining that the frequency band identified from the second network information is included in the at least one candidate frequency band, transmit, to the IoT device, via the first communication circuitry or the second communication circuity, the second network information. The instructions, when executed by the at least one processor individually or collectively, may cause the electronic device to, based on determining that the frequency band identified from the second network information is not included in the at least one candidate frequency band, refrain from transmitting, to the IoT device, via the first communication circuitry or the second communication circuity, the second network information. The frequency band identified from the second network information may represent a frequency band of a wireless network provided by the AP device or the another AP device.

According to an embodiment, the electronic device may further comprise a display. The first communication circuity may be used for wireless fidelity (Wi-Fi) communication. The instructions, when executed by the at least one processor individually or collectively, may cause the electronic device to, based on the failure of accessing the AP device using the first network information, display, via the display, a screen for obtaining the second network information. The second network information may include a second SSID and a second password for accessing the AP device or the another AP device. The instructions, when executed by the at least one processor individually or collectively, may cause the electronic device to identify an input received regarding the screen. The instructions, when executed by the at least one processor individually or collectively, may cause the electronic device to, based on the input, obtain the second network information. The instructions, when executed by the at least one processor individually or collectively, may cause the electronic device to attempt to access the AP device or the another AP device using the second network information. The instructions, when executed by the at least one processor individually or collectively, may cause the electronic device to, based on the success of accessing the AP device or the another AP device using the second network information, establish, via the first communication circuitry or the second communication circuitry, a direct communication link with the IoT device for transmitting the second network information to the IoT device. The instructions, when executed by the at least one processor individually or collectively, may cause the electronic device to transmit, to the server device, via the first communication circuitry, a third message including the second network information available for accessing the AP device or the another AP device.

According to an embodiment, the third message may represent that the second network information is used for a first external electronic device to access a second external electronic device or the other AP device.

According to an embodiment, the third message may be used to update from the first network information to the second network information.

As described above, a method performed by an electronic device including first communication circuitry and second communication circuitry may comprise receiving, from a server device, via the first communication circuitry, a first message representing that a network connection problem occurred in association with an access point (AP) device. One or more IoT devices may be registered in the server device in association with the electronic device. The method may comprise, based on receiving the first message, attempting to access the access point (AP) device, using first network information included in the first message. The first network information may be used by the one or more IoT devices for accessing the AP device. The method may comprise, based on a success of accessing the AP device in accordance with the attempt using the first network information, transmitting, to the server device, via the first communication circuitry, a second message representing that the first network information is available for an access to the AP device. The method may comprise, based on a failure of accessing the AP device in accordance with the attempt using the first network information, obtaining second network information for accessing the AP device or another AP device. The method may comprise, based on a success of accessing the AP device or the another AP device using the second network information, transmitting, to the IoT device registered in the server device, via the first communication circuitry or the second communication circuitry, the second network information.

As described above, a non-transitory computer readable storage medium may store one or more programs including instructions, when executed by an electronic device including first communication circuitry and second communication circuitry, that cause the electronic device to receive, from a server device, via the first communication circuitry, a first message representing that a network connection problem occurred in association with an access point (AP) device. One or more IoT devices may be registered in the server device in association with the electronic device. The non-transitory computer readable storage medium may store the one or more programs including the instructions, when executed by the electronic device, that cause the electronic device to, based on receiving the first message, attempt to access the access point (AP) device, using first network information included in the first message. The first network information may be used by the one or more IoT devices for accessing the AP device. The non-transitory computer readable storage medium may store the one or more programs including the instructions, when executed by the electronic device, that cause the electronic device to, based on a success of accessing the AP device in accordance with the attempt using the first network information, transmit, to the server device, via the first communication circuitry, a second message representing that the first network information is available for an access to the AP device. The non-transitory computer readable storage medium may store the one or more programs including the instructions, when executed by the electronic device, that cause the electronic device to, based on a failure of accessing the AP device in accordance with the attempt using the first network information, obtain second network information for accessing the AP device or another AP device. The non-transitory computer readable storage medium may store the one or more programs including the instructions, when executed by the electronic device, that cause the electronic device to, based on a success of accessing the AP device or the another AP device using the second network information, transmit, to the IoT device registered in the server device, via the first communication circuitry or the second communication circuitry, the second network information.

According to an embodiment, the second network information may be transmitted from the electronic device to the IoT device registered with respect to the AP device through a direct communication link between the electronic device and the IoT device registered with respect to the AP device.

The effects that can be obtained from the disclosure are not limited to those described above, and any other effects not mentioned herein will be clearly understood by those having ordinary knowledge in the art to which the disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," or "connected with" another element (e.g., a second element), it means that the element may be coupled with the other element directly (e.g., wiredly), wirelessly, or via a third element.

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a server device, the method comprising:
identifying a connection status with the server device of an internet of things (IoT) device;
based on the connection status of the IoT device being an offline status, identifying a connection status of one or more other IoT devices, registered with respect to an access point (AP) device to which the IoT device connects for connecting to the server device;
based on the connection status of the one or more other IoT devices being the offline status, transmitting, to an electronic device, a first message representing that a network connection problem occurred in association with the AP device, the first message including first network information used for accessing the AP device such that the electronic device determines whether the first network information is available for accessing the AP device; and
receiving a second message including second network information available for accessing the AP device or another AP device, transmitted from the electronic device such that the first network information is updated to the second network information.

2. The method of claim 1, wherein the second network information is transmitted from the electronic device to the IoT device registered with respect to the AP device through a direct communication link between the electronic device and the IoT device registered with respect to the AP device.

3. The method of claim 1, wherein the identifying of the connection status with the server device of the IoT device comprises:
receiving, from the electronic device, a control command for controlling the IoT device registered in association with the electronic device;
transmitting a request signal including the control command to the IoT device and activating a timer; and
based on a response signal associated with the request signal being not received until expiration of the timer, identifying that the connection status of the IoT device is the offline status with the server device.

4. The method of claim 3, wherein the identifying that the connection status of the IoT device is the offline status with the server device comprises:
based on identifying that the connection status of the IoT device is the offline status with the server device, identifying the AP device, registered with respect to a place in which the IoT device is positioned, to which the IoT device was accessed for a connection with the server device.

5. The method of claim 1,
wherein the second message represents that the IoT device registered with respect to the AP device and the electronic device are positioned in a place in which the AP device is positioned,
wherein a second password, included in the second network information in the second message, is different from a first password, included in the first network information in the first message, and
wherein the second password allows the IoT device to access the AP device.

6. The method of claim 1,
wherein the second message represents that the IoT device registered with respect to the AP device and the electronic device are positioned in a place in which the AP device is positioned,
wherein a second service set identifier (SSID), included in the second network information in the second message, is different from a first SSID, included in the first network information in the first message, and
wherein the second SSID allows the IoT devices to access the AP device.

7. The method of claim 1,
wherein the second message represents that the IoT device registered with respect to the AP device and the electronic device are positioned in a place in which the AP device is positioned,
wherein a second SSID and a second password, included in the second network information in the second message, are different from a first SSID and a first password, included in the first network information in the first message, and
wherein the second SSID and the second password allow the IoT device to access the AP device.

8. A server device comprising:
memory comprising one or more storage media storing instructions; and
at least one processor including processing circuitry,
wherein the instructions, when executed by the at least one processor individually or collectively, cause the server device to:
identify a connection status with the server device of an internet of things (IoT) device,
based on the connection status of the IoT device being an offline status, identify a connection status of one or more other IoT devices, registered with respect to an access point (AP) device to which the IoT device was accessed for connecting to the server device,
based on the connection status of the one or more other IoT devices being the offline status, transmit, to an electronic device, a first message representing that a network connection problem occurred in association with the AP device, the first message including first network information used for accessing the AP device, such that the electronic device determines whether the first network information is available for accessing the AP device, and
receive a second message, including second network information available for accessing the AP device or another AP device, transmitted from the electronic device, such that the first network information is updated to the second network information.

9. The server device of claim 8, wherein the second network information is transmitted from the electronic device to the IoT device registered with respect to the AP device through a direct communication link between the electronic device and the IoT device registered with respect to the AP device.

10. The server device of claim 8, wherein the instructions, when executed by the at least one processor individually or collectively, further cause the server device to:
receive, from the electronic device, a control command for controlling the IoT device registered in association with the electronic device;
transmit a request signal including the control command to the IoT device and activate a timer; and
based on a response signal associated with the request signal being not received until expiration of the timer, identify that the connection status of the IoT device is the offline status with the server device.

11. The server device of claim 10, wherein the instructions, when executed by the at least one processor individually or collectively, further cause the server device to:
based on identifying that the connection status of the IoT device is the offline status with the server device, identify the AP device, registered with respect to a place in which the IoT device is positioned, to which the IoT device was accessed for a connection with the server device.

12. The server device of claim 8,
wherein the second message represents that the IoT device registered with respect to the AP device and the electronic device are positioned in a place in which the AP device is positioned,
wherein a second password, included in the second network information in the second message, is different from a first password, included in the first network information in the first message, and
wherein the second password allows the IoT device to access the AP device.

13. The server device of claim 8,
wherein the second message represents that the IoT device registered with respect to the AP device and the electronic device are positioned in a place in which the AP device is positioned,
wherein a second service set identifier (SSID), included in the second network information in the second message, is different from a first SSID, included in the first network information in the first message, and
wherein the second SSID allows the IoT device to access the AP device.

14. The server device of claim 8,
wherein the second message represents that the IoT device registered with respect to the AP device and the electronic device are positioned in a place in which the AP device is positioned,
wherein a second SSID and a second password included in the second network information in the second message, are different from a first SSID and a first password, included in the first network information in the first message, and
wherein the second SSID and the second password allow the IoT device to access the AP device.

15. An electronic device comprising:
first communication circuitry;
second communication circuitry;
memory comprising one or more storage media storing instructions; and
at least one processor comprising processing circuitry,
wherein the instructions, when executed by the at least one processor individually or collectively, cause the electronic device to:
receive, from a server device, via the first communication circuitry, a first message representing that a network connection problem occurred in association with an access point (AP) device, wherein one or more internet of things (IoT) devices are registered in the server device in association with the electronic device,
based on receiving the first message, attempt to access the AP device, using first network information included in the first message, the first network information used by the one or more IoT devices for accessing the AP device,
based on a success of accessing the AP device in accordance with the attempt using the first network information, transmit, to the server device, via the first communication circuitry, a second message representing that the first network information is available for an access to the AP device,
based on a failure of accessing the AP device in accordance with the attempt using the first network information, obtain second network information for accessing the AP device or another AP device, and
based on a success of accessing the AP device or the another AP device using the second network information, transmit, to the IoT device registered in the server device, via the first communication circuitry or the second communication circuitry, the second network information.

16. The electronic device of claim 15, wherein the instructions, when executed by the at least one processor individually or collectively, further cause the electronic device to:
based on receiving the first network information from the server device, identify the first network information which was used by the one or more IoT devices for accessing the AP device;
attempt to access the AP device using a first service set identifier (SSID) and a first password in the first network information;
based on a failure of accessing the AP device in accordance with the attempt performed using the first SSID and the first password, identify third network information which was used by the electronic device for accessing the AP device, a third network device including a third SSID and a third password which was used by the electronic device for accessing the AP device;
attempt to access the AP device using the third network information; and
based on a failure of accessing the AP device in accordance with the attempt using the third network information, obtain the second network information for accessing the AP device.

17. The electronic device of claim 15, wherein the instructions, when executed by the at least one processor individually or collectively, further cause the electronic device to:
based on receiving the first message from the server device, identify a first SSID and a first password in the first network information;
identify that the IoT device is positioned within a reference region defined from the electronic device; and
in accordance with the IoT device positioned in the reference region defined from the electronic device, perform the attempt using the first SSID and the first password in the first network information.

18. The electronic device of claim 17,
wherein the second communication circuitry is used for Bluetooth low energy (BLE) communication, and
wherein the instructions, when executed by the at least one processor individually or collectively, further cause the electronic device to:
receive, via the second communication circuitry, signals broadcasted from the IoT device,
based on receiving the broadcasted signals, identify a hardware identifier for indicating the IoT device registered in the server device, and
based on identifying that the identified hardware identifier is the same as a hardware identifier representing the IoT device registered in the server device stored in the electronic device, identify that the IoT device is positioned within the reference region defined from the electronic device.

19. The electronic device of claim 15,
wherein the instructions, when executed by the at least one processor individually or collectively, further cause the electronic device to:
based on the success of accessing the AP device or the another AP device using a second SSID and a second password in the second network information, identify, from the second network information, a frequency band used for accessing the AP device,
identify at least one candidate frequency band available in the IoT device from the first network information which was used by the IoT device for accessing the AP device,
determine whether the frequency band identified from the second network information is included in the at least one candidate frequency band,
based on determining that the frequency band identified from the second network information is included in the at least one candidate frequency band, transmit, to the IoT device, via the first communication circuitry or the second communication circuity, the second network information, and
based on determining that the frequency band identified from the second network information is not included in the at least one candidate frequency band, refrain from transmitting, to the IoT device, via the first communication circuitry or the second communication circuity, the second network information, and
wherein the frequency band identified from the second network information represents a frequency band of a wireless network provided by the AP device or the another AP device.

20. The electronic device of claim 15,
wherein the electronic device further comprises a display,
wherein the first communication circuity is used for wireless fidelity (Wi-Fi) communication, and
wherein the instructions, when executed by the at least one processor individually or collectively, further cause the electronic device to:
based on the failure of accessing the AP device using the first network information, display, via the display, a screen for obtaining the second network information, the second network information including a second SSID and a second password for accessing the AP device or the another AP device,
identify an input received regarding the screen,
based on the input, obtain the second network information,
attempt to access the AP device or the another AP device using the second network information,
based on the success of accessing the AP device or the another AP device using the second network information, establish, via the first communication circuitry or the second communication circuitry, a direct communication link with the IoT device for transmitting the second network information to the IoT device, and
transmit, to the server device, via the first communication circuitry, a third message including the second network information available for accessing the AP device or the another AP device.
